(19) United States
(12) Patent Application Publication
(10) Pub. No.: US 2025/0383572 A1
(43) Pub. Date: Dec. 18, 2025

(54) COMMISSIONING OPTICALLY SWITCHABLE WINDOWS

(71) Applicant: View Operating Corporation, San Jose, CA (US)

(72) Inventors: Michael Edgar LARSON, Los Gatos, CA (US); Stephen Clark BROWN, San Mateo, CA (US); Philip Francis KEARNEY, San Jose, CA (US); John R. SANFORD, Escondido, CA (US); Robert Michael MARTINSON, Palo Alto, CA (US)

(73) Assignee: View Operating Corporation, San Jose, CA (US)

(21) Appl. No.: 19/316,053

(22) Filed: Sep. 2, 2025

Related U.S. Application Data
(63) Continuation of application No. PCT/US2024/018692, filed on Mar. 6, 2024.
(60) Provisional application No. 63/490,724, filed on Mar. 16, 2023.

(51) Int. Cl. G02F 1/163; G02F 1/155

(52) U.S. Cl. CPC G02F 1/163; G02F 1/155; G02F 2001/1555

(57) ABSTRACT

Various embodiments herein relate to methods, controllers, and control systems for commissioning a network of electrochromic windows. Such commissioning methods can involve perturbing a window (e.g., externally or internally), thereby causing the window to generate or receive a signal. This signal can be converted to an electrical signal, if needed. The signal is then propagated from the window that is perturbed, through its associated window controller, and onto an upstream portion of the control system for the network. The association between the window that is perturbed and its associated window controller can then be determined based on, e.g., which window is perturbed and which window controller propagates the signal. Many types of perturbations and signals can be used.

### INCORPORATED BY REFERENCE

The present application is a continuation of International Application No. PCT/US2024/018692, filed on Mar. 6, 2024, which claims the benefit of U.S. Provisional Patent Application Ser. No. 63/490,724, filed Mar. 16, 2023. Each application that the present application claims benefit of or priority to as identified is incorporated by reference herein in its entirety and for all purposes.

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance. One well known electrochromic material is tungsten oxide (WO₃). Tungsten oxide is a cathodic electrochromic material in which a coloration transition, transparent to blue, occurs by electrochemical reduction.

Electrochromic materials may be incorporated into, for example, windows for residential, commercial, and other uses. The color, transmittance, absorbance, and/or reflectance of such windows may be changed by changing a feature of the electrochromic material, that is, electrochromic windows are windows that can be darkened or lightened electronically. A small voltage applied to an electrochromic device of the window will cause them to darken; reversing the voltage causes them to lighten. This capability allows control of the amount of light that passes through the windows, and presents an opportunity for electrochromic windows to be used as energy-saving devices.

While electrochromism was discovered in the 1960s, electrochromic devices, and particularly electrochromic windows, still suffer various problems and have not begun to realize their full commercial potential despite many recent advancements in electrochromic technology, apparatus, software, and related methods of making and/or using electrochromic devices.

### SUMMARY

Various embodiments herein relate to methods and control systems for determining associations between an optically switchable window and its associated window controller in a network of optically switchable windows. In one aspect of the disclosed embodiments, such a method includes: perturbing the optically switchable window to cause the optically switchable window to generate or receive a signal; propagating the signal from the optically switchable window, through its associated window controller, to an upstream portion of the network; and determining the association between the optically switchable window and its associated window controller based on which optically switchable window was perturbed and which window controller propagated the signal.

In some embodiments, the method may further include recording a location of the optically switchable window that is perturbed. In these or other embodiments, the method may further include determining an identification number for the optically switchable window that is perturbed, where the identification number is determined based on an identification number stored on a memory chip that is integral with or connected to the optically switchable window that is perturbed. In these or other embodiments, the method may further include determining an association between (1) the identification number for the optically switchable window that is perturbed, and (2) the location of the optically switchable window that is perturbed.

In various embodiments, determining the association between the optically switchable window and its associated window controller may include determining an association between (1) the identification number for the optically switchable window that is perturbed, and (2) an identification number for the associated window controller that propagates the signal. In various embodiments, perturbing the optically switchable window may include one or more actions from the group consisting of: physically contacting one or more component of the optically switchable window or its associated frame, causing a pressure change in one or more component of the optically switchable window, causing vibrations in one or more component of the optically switchable window, directing sound toward one or more component of the optically switchable window, directing an electrical signal toward one or more component of the optically switchable window, directing an RF signal toward one or more component of the optically switchable window, or a combination thereof.

In various embodiments, the method may further include converting a signal generated or received by the optically switchable window that is perturbed to an electrical signal, where the electrical signal is the signal that is propagated through the associated window controller and to the upstream portion of the network. In various embodiments, the optically switchable window may be perturbed by a source external to the optically switchable window. In some such embodiments, the source that perturbs the optically switchable window may be an installer, robot, or drone.

In various embodiments, the method may further include instructing the optically switchable window to perturb itself. In some such cases, the optically switchable window that perturbs itself may include bus bars and/or an antenna, and the optically switchable window may perturb and/or identify itself by transmitting a signal using the bus bars and/or the antenna. In some such embodiments, the method may further include detecting the signal transmitted by the bus bars and/or antenna to determine a physical location of the optically switchable window that is perturbed, and recording the physical location of the optically switchable window that is perturbed.

In various embodiments, the method may further include repeating the method on different optically switchable windows until all of the associations between each optically switchable window and its associated window controller are determined.

In another aspect of the disclosed embodiments, a control system for a network of optically switchable windows is provided, the control system including: a plurality of optically switchable windows, each having an associated window controller; an upstream portion of the control system, the upstream portion of the control system being functionally upstream from the plurality of optically switchable windows and their associated window controllers; and a memory configured to cause: perturbing a first optically switchable window of the plurality of optically switchable windows to cause the first optically switchable window to generate or receive a signal, propagating the signal from the first optically switchable window, through its associated window controller, to the upstream portion of the control system, and determining the association between the first optically switchable window and its associated window controller based on which optically switchable window was perturbed and which window controller propagated the signal.

In some embodiments, the control system may be configured to accept as input a location of the first optically switchable window, the location being determined by an installer, robot, or drone who perturbs the first optically switchable window or otherwise causes the first optically switchable window to be perturbed. In some embodiments, the memory may be further configured to cause determining an identification number for the first optically switchable window, where the identification number is determined based on an identification number stored on a memory chip that is integral with or connected to the first optically switchable window.

In various embodiments, the memory may be further configured to cause determining an association between (1) the identification number for the first optically switchable window, and (2) the location of the first optically switchable window. In some embodiments, the memory may be configured to cause determining the association between the first optically switchable window and its associated window controller by determining an association between (1) the identification number for the first optically switchable window, and (2) an identification number for the associated window controller that propagates the signal.

In various embodiments, the memory may be configured to cause perturbing the first optically switchable window by causing one or more actions from the group consisting of: physically contacting one or more component of the first optically switchable window or its associated frame, causing a pressure change in one or more component of the first optically switchable window, causing vibrations in one or more component of the first optically switchable window, directing sound toward one or more component of the first optically switchable window, directing an electrical signal toward one or more component of the first optically switchable window, directing an RF signal toward one or more component of the first optically switchable window, or a combination thereof.

In some embodiments, the memory may be further configured to cause converting a signal generated or received by the first optically switchable window to an electrical signal, where the electrical signal is the signal that is propagated through the associated window controller and to the upstream portion of the control system.

In various embodiments, the first optically switchable window may be perturbed by a source external to the first optically switchable window. In some such embodiments, the source that perturbs the first optically switchable window may be an installer, robot, or drone.

In various embodiments, the memory may be further configured to cause the first optically switchable window to perturb itself. In some such embodiments, the first optically switchable window may include bus bars and/or an antenna, and the first optically switchable window may perturb and/or identify itself by transmitting a signal using the bus bars and/or the antenna. In these or other embodiments, the signal transmitted by the bus bars and/or antenna may be detected by an installer, robot, or drone to determine a physical location of the first optically switchable window.

These and other features and embodiments will be described in more detail with reference to the drawings.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The figures and components therein may not be drawn to scale.

FIG. 1A is a schematic drawing of a cross-section of an electrochromic lite, according to implementations.

FIG. 1B is a schematic drawing of a cross-section of the electrochromic lite in FIG. 1A.

FIG. 1C is a schematic drawing of a top down view of the electrochromic lite in FIG. 1A.

FIG. 2A is a schematic drawing of a cross-section of an IGU with the electrochromic lite described in relation to FIGS. 1A-1C, according to implementations.

FIG. 2B is a schematic drawing of a cross-section of an electrochromic device, described in relation to FIGS. 1A-1C and a reinforcing pane laminated thereon, according to implementations.

FIG. 3A is a schematic drawing of a cross-section of an electrochromic device, according to implementations.

FIG. 3B is a schematic drawing of a cross-section of an electrochromic device in a bleached state, according to implementations.

FIG. 3C is a schematic drawing of a cross-section of an electrochromic device in a colored state, according to implementations.

FIG. 4 is a simplified block diagram of components of a window controller and components of a window controller system, according to implementations.

FIG. 5 is a schematic diagram of a control system for controlling tint of a plurality of tintable windows in a building, according to implementations.

FIG. 6 is a schematic diagram of a network system with a building management system (BMS), a plurality of distributed local window controllers (WCs), a plurality of network controllers (NCs), and a master controller (MC), according to implementations.

FIG. 7 is a schematic diagram of a plurality of tintable windows grouped into zones, according to implementations.

FIG. 8 is a flowchart depicting a method of determining associations between electrochromic windows and their associated window controllers according to various embodiments herein.

FIG. 9 is a flowchart depicting an additional method of determining associations between electrochromic windows and their associated window controllers according to various embodiments herein.

FIGS. 10A-10J show cross-sectional views of example electrochromic window structures with integrated antennas capable of transmitting signals into, or receiving signals from, an interior environment according to some implementations.

### DETAILED DESCRIPTION

Different aspects are described below with reference to the accompanying drawings. The features illustrated in the drawings may not be to scale. In the following description, numerous specific details are set forth in order to provide a thorough understanding of the presented implementations. The disclosed implementations may be practiced without one or more of these specific details. In other instances, well-known operations have not been described in detail to avoid unnecessarily obscuring the disclosed implementations. While the disclosed implementations will be described in conjunction with specific examples, it will be understood that it is not intended to limit the disclosed implementations.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The term “tintable window” refers to a window (e.g., an architectural window) comprising one or more optically switchable devices (e.g., electrochromic devices or other optically switchable devices). An example of a tintable window is an electrochromic window having one or more tintable devices. In examples involving commissioning of tintable windows, a tintable window is sometimes referred to as an “insulated glass unit” or “IGU.”

The headings provided herein are not intended to limit the disclosure.

Unless defined otherwise herein, all technical and scientific terms used herein have the same meaning as commonly understood by one of ordinary skill in the art. Various scientific dictionaries that include the terms included herein are well known and available to those in the art. Although any methods and materials similar or equivalent to those described herein find use in the practice or testing of the embodiments disclosed herein, some methods and materials are described.

The terms defined immediately below are more fully described by reference to the Specification as a whole. It is to be understood that this disclosure is not limited to the particular methodology, protocols, and reagents described, as these may vary, depending upon the context they are used by those of skill in the art.

As used herein, the singular terms “a,” “an,” and “the” include the plural reference unless the context clearly indicates otherwise.

### I. Introduction and Context of Tintable Windows and Window Controllers

In order to orient the reader to the embodiments of systems, apparatus, and methods disclosed herein, a brief discussion of electrochromic devices, tintable windows, and window controllers is provided. This initial discussion is provided for context only, and the subsequently described embodiments are not limited to the specific features and fabrication processes of this initial discussion. Moreover, it would be understood that a tintable window may include one or more electrochromic devices in some aspects, and in addition or alternatively, may include one or more other optically switchable devices in other aspects. Examples of other types of optically switchable devices that may be used include, but are not limited to, liquid crystal devices and suspended particle devices.

### A. Electrochromic Devices

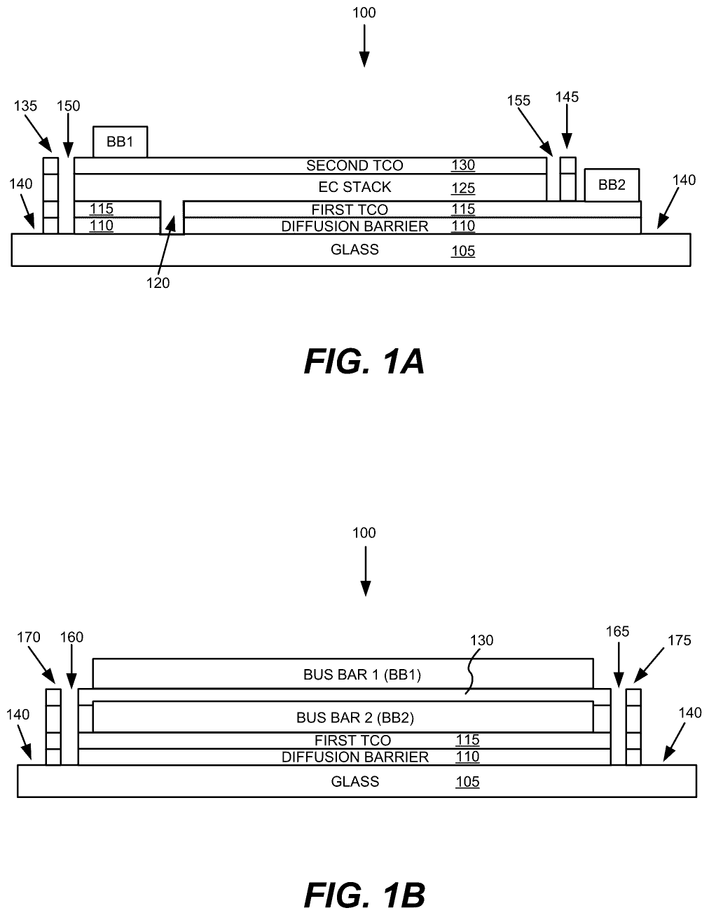

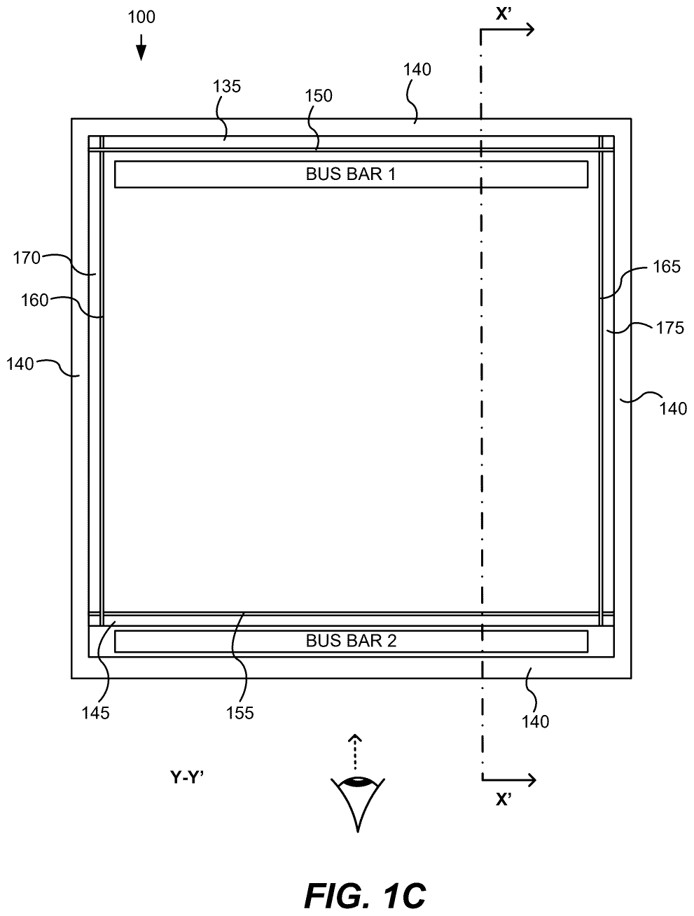

A particular example of an electrochromic lite is described with reference to FIGS. 1A-1C, in order to illustrate embodiments described herein. FIG. 1A is a cross-sectional representation (see section cut X′-X′ of FIG. 1C) of an electrochromic lite 100, which is fabricated starting with a glass sheet 105. FIG. 1B shows an end view (see viewing perspective Y-Y′ of FIG. 1C) of electrochromic lite 100, and FIG. 1C shows a top-down view of electrochromic lite 100. FIG. 1A shows the electrochromic lite after fabrication on glass sheet 105, edge deleted to produce area 140, around the perimeter of the lite. The electrochromic lite has also been laser scribed and bus bars have been attached. A bus bar (also busbar) is a metallic strip or bar for distributing current. The glass lite 105 has a diffusion barrier 110, and a first transparent conducting oxide layer (TCO) 115, on the diffusion barrier. In this example, the edge deletion process removes both first TCO 115 and diffusion barrier 110, but in other embodiments only the TCO is removed, leaving the diffusion barrier intact. The first TCO 115 is the first of two conductive layers used to form the electrodes of the electrochromic device fabricated on the glass sheet. In this example, the glass sheet includes underlying glass and the diffusion barrier layer. Thus, in this example, the diffusion barrier is formed, and then the first TCO, an electrochromic stack 125, (e.g., having electrochromic, ion conductor, and counter electrode layers), and a second TCO 130, are formed. In one embodiment, the electrochromic device (electrochromic stack and second TCO) is fabricated in an integrated deposition system where the glass sheet does not leave the integrated deposition system at any time during fabrication of the stack. In one embodiment, the first TCO layer is also formed using the integrated deposition system where the glass sheet does not leave the integrated deposition system during deposition of the electrochromic stack and the (second) TCO layer. In one embodiment, all the layers (diffusion barrier, first TCO, electrochromic stack, and second TCO) are deposited in the integrated deposition system where the glass sheet does not leave the integrated deposition system during deposition. In this example, prior to deposition of electrochromic stack 125, an isolation trench 120, is cut through first TCO 115 and diffusion barrier 110. Isolation trench 120 is made in contemplation of electrically isolating an area of first TCO 115 that will reside under bus bar 1 after fabrication is complete (see FIG. 1A). This is done to avoid charge buildup and coloration of the electrochromic device under the bus bar, which can be undesirable.

After formation of the electrochromic device, edge deletion processes and additional laser scribing are performed. FIG. 1A depicts areas 140 where the device has been removed, in this example, from a perimeter region surrounding laser scribe trenches 150, 155, 160, and 165. Laser scribe trenches 150, 160 and 165 pass through the electrochromic stack and also through the first TCO and diffusion barrier. Laser scribe trench 155 passes through second TCO 130 and the electrochromic stack, but not the first TCO 115. Laser scribe trenches 150, 155, 160, and 165 are made to isolate portions of the electrochromic device, 135, 145, 170, and 175, which were potentially damaged during edge deletion processes from the operable electrochromic device. In this example, laser scribe trenches 150, 160, and 165 pass through the first TCO to aid in isolation of the device (laser scribe trench 155 does not pass through the first TCO, otherwise it would cut off bus bar 2's electrical communication with the first TCO and thus the electrochromic stack). The laser or lasers used for the laser scribe processes are typically, but not necessarily, pulse-type lasers, for example, diode-pumped solid-state lasers. For example, the laser scribe processes can be performed using a suitable laser from IPG Photonics (of Oxford, Massachusetts), or from Ekspla (of Vilnius, Lithuania). Scribing can also be performed mechanically, for example, by a diamond tipped scribe. One of ordinary skill in the art would appreciate that the laser scribing processes can be performed at different depths and/or performed in a single process whereby the laser cutting depth is varied, or not, during a continuous path around the perimeter of the electrochromic device. In one embodiment, the edge deletion is performed to the depth of the first TCO.

After laser scribing is complete, bus bars are attached. Non-penetrating bus bar 1 is applied to the second TCO. Non-penetrating bus bar 2 is applied to an area where the device was not deposited (e.g., from a mask protecting the first TCO from device deposition), in contact with the first TCO or, in this example, where an edge deletion process (e.g., laser ablation using an apparatus having an XY or XYZ galvanometer) was used to remove material down to the first TCO. In this example, both bus bar 1 and bus bar 2 are non-penetrating bus bars. A penetrating bus bar is one that is typically pressed into and through the electrochromic stack to make contact with the TCO at the bottom of the stack. A non-penetrating bus bar is one that does not penetrate into the electrochromic stack layers, but rather makes electrical and physical contact on the surface of a conductive layer, for example, a TCO.

The TCO layers can be electrically connected using a non-traditional bus bar, for example, a bus bar fabricated with screen and lithography patterning methods. In one embodiment, electrical communication is established with the device's transparent conducting layers via silk screening (or using another patterning method) a conductive ink followed by heat curing or sintering the ink. Advantages to using the above described device configuration include simpler manufacturing, for example, and less laser scribing than conventional techniques which use penetrating bus bars.

After the bus bars are connected, the device is integrated into an insulated glass unit (IGU), which includes, for example, wiring for the bus bars and the like. In some embodiments, one or both of the bus bars are inside the finished IGU, however in one embodiment one bus bar is outside the seal of the IGU and one bus bar is inside the IGU. In the former embodiment, area 140 is used to make the seal with one face of the spacer used to form the IGU. Thus, the wires or other connection to the bus bars runs between the spacer and the glass. As many spacers are made of metal, e.g., stainless steel, which is conductive, it is desirable to take steps to avoid short circuiting due to electrical communication between the bus bar and connector thereto and the metal spacer. In the embodiments described herein, both of the bus bars are inside the primary seal of the finished IGU.

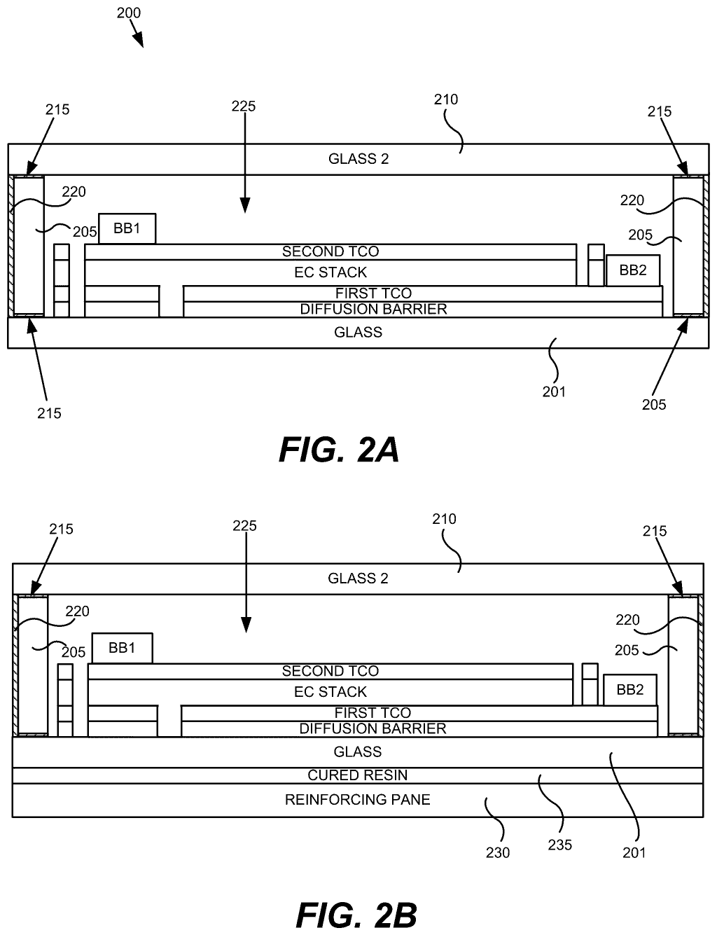

FIG. 2A shows a cross-sectional schematic diagram of the electrochromic lite described in relation to FIGS. 1A-1C integrated into an IGU 200. A spacer 205 is used to separate the electrochromic lite from a second lite 210. Second lite 210 in IGU 200 is a non-electrochromic lite, however, the embodiments disclosed herein are not so limited. For example, second lite 210 can have an electrochromic device thereon and/or one or more coatings such as low-E coatings and the like. Lite 201 can be laminated glass, such as depicted in FIG. 2B (lite 201 is laminated to reinforcing pane 230, via resin 235). Between spacer 205 and the lite 201 of the electrochromic lite is a primary seal material 215. This primary seal material is also between spacer 205 and second lite 210. Around the perimeter of spacer 205 is a secondary seal 220. Bus bar wiring/leads traverse the seals for connection to a controller. Secondary seal 220 may be much thicker that depicted. These seals aid in keeping moisture out of an interior volume 225, of the IGU. They also serve to prevent argon or other gas in the interior of the IGU from escaping.

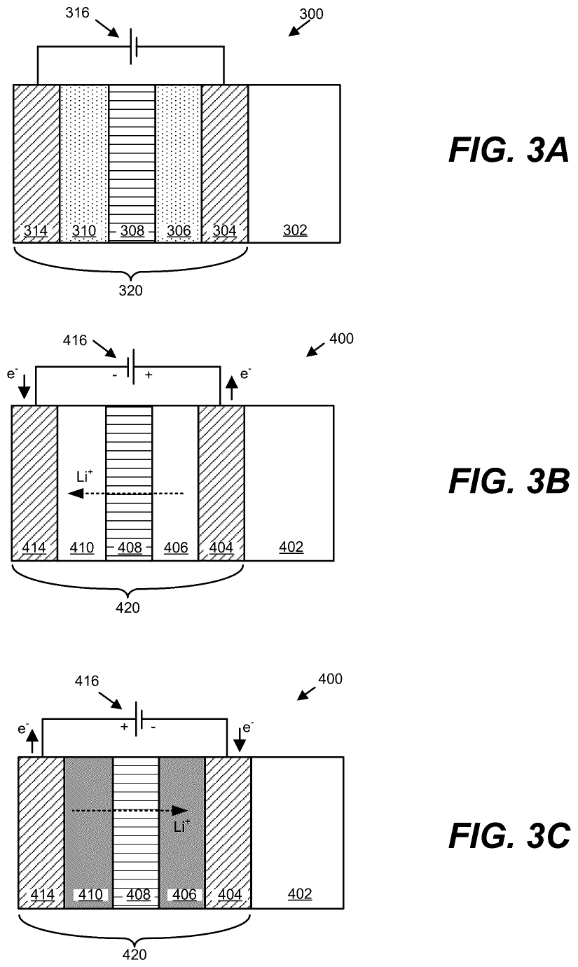

FIG. 3A schematically depicts an electrochromic device 300, in cross-section. Electrochromic device 300 includes a substrate 302, a first conductive layer (CL) 304, an electrochromic layer (EC) 306, an ion conducting layer (IC) 308, a counter electrode layer (CE) 310, and a second conductive layer (CL) 314. Layers 304, 306, 308, 310, and 314 are collectively referred to as an electrochromic stack 320. A voltage source 316 operable to apply an electric potential across electrochromic stack 320 effects the transition of the electrochromic device from, for example, a bleached state to a colored state (depicted). The order of layers can be reversed with respect to the substrate.

Electrochromic devices having distinct layers as described can be fabricated as all solid-state devices and/or all inorganic devices. Such devices and methods of fabricating them are described in more detail in U.S. patent application Ser. No. 12/645,111, entitled “Fabrication of Low-Defectivity Electrochromic Devices,” filed on Dec. 22, 2009, and naming Mark Kozlowski et al. as inventors, and in U.S. patent application Ser. No. 12/645,159, entitled, “Electrochromic Devices,” filed on Dec. 22, 2009 and naming Zhongchun Wang et al. as inventors, both of which are hereby incorporated by reference in their entireties. It should be understood, however, that any one or more of the layers in the stack may contain some amount of organic material. The same can be said for liquids that may be present in one or more layers in small amounts. It should also be understood that solid state material may be deposited or otherwise formed by processes employing liquid components such as certain processes employing sol-gels or chemical vapor deposition.

Additionally, it should be understood that the reference to a transition between a bleached state and colored state is non-limiting and suggests only one example, among many, of an electrochromic transition that may be implemented. Unless otherwise specified herein (including the foregoing discussion), whenever reference is made to a bleached-colored transition (or equivalently a clear-tinted transition), the corresponding device or process encompasses other optical state transitions such as non-reflective-reflective, transparent-opaque, etc. Further, the term “bleached” or “clear” refers to an optically neutral state, for example, uncolored, transparent, or translucent. Still further, unless specified otherwise herein, the “color” or “tint” of an electrochromic transition is not limited to any particular wavelength or range of wavelengths. As understood by those of skill in the art, the choice of appropriate electrochromic and counter electrode materials governs the relevant optical transition.

In embodiments described herein, the electrochromic device reversibly cycles between a bleached/clear state and a colored/tinted state. In some cases, when the device is in a bleached state, a potential is applied to the electrochromic stack 320 such that available ions in the stack reside primarily in the counter electrode layer 310. When the potential on the electrochromic stack is reversed, the ions are transported across the ion conducting layer 308 to the electrochromic material in the electrochromic layer 306 and cause the material to transition to the colored state. In a similar way, the electrochromic device of embodiments described herein can be reversibly cycled between different tint levels (e.g., bleached state, darkest colored state, and intermediate levels between the bleached state and the darkest colored state).

Referring again to FIG. 3A, voltage source 316 may be configured to operate in conjunction with radiant and other environmental sensors. As described herein, voltage source 316 interfaces with a device controller (not shown in this figure). Additionally, voltage source 316 may interface with an energy management system that controls the electrochromic device according to various criteria such as the time of year, time of day, and measured environmental conditions. Such an energy management system, in conjunction with large area electrochromic devices (e.g., an electrochromic window), can dramatically lower the energy consumption of a building.

Any material having suitable optical, electrical, thermal, and mechanical properties may be used as substrate 302. Such substrates include, for example, glass, plastic, and mirror materials. Suitable glasses include either clear or tinted soda lime glass, including soda lime float glass. The glass may be tempered or untempered.

In many cases, the substrate is a glass pane sized for residential window applications. The size of such glass pane can vary widely depending on the specific needs of the residence. In other cases, the substrate is architectural glass. Architectural glass is typically used in commercial buildings, but may also be used in residential buildings, and typically, though not necessarily, separates an indoor environment from an outdoor environment. In certain embodiments, architectural glass is at least 20 inches by 20 inches, and can be much larger, for example, as large as about 80 inches by 120 inches. Architectural glass is typically at least about 2 mm thick, typically between about 3 mm and about 6 mm thick. Of course, electrochromic devices are scalable to substrates smaller or larger than architectural glass. Further, the electrochromic device may be provided on a mirror of any size and shape.

On top of substrate 302 is first conductive layer 304. In certain embodiments, one or both of the conductive layers 304 and 314 are inorganic and/or solid. Conductive layers 304 and 314 may be made from a number of different materials, including conductive oxides, thin metallic coatings, conductive metal nitrides, and composite conductors. Typically, conductive layers 304 and 314 are transparent at least in the range of wavelengths where electrochromism is exhibited by the electrochromic layer. Transparent conductive oxides include metal oxides and metal oxides doped with one or more metals. Examples of such metal oxides and doped metal oxides include indium oxide, indium tin oxide, doped indium oxide, tin oxide, doped tin oxide, zinc oxide, aluminum zinc oxide, doped zinc oxide, ruthenium oxide, doped ruthenium oxide and the like. Since oxides are often used for these layers, they are sometimes referred to as “transparent conductive oxide” (TCO) layers. Thin metallic coatings that are substantially transparent may also be used, as well as combinations of TCO's and metallic coatings.

In some embodiments, commercially available substrates such as glass substrates contain a transparent conductive layer coating. Such products may be used for both substrate and conductive layer. Examples of such glasses include conductive layer coated glasses sold under the trademark TEC Glass™ by Pilkington, of Toledo, Ohio and SUNGATE™ 300 and SUNGATE™ 500 by PPG Industries of Pittsburgh, Pennsylvania. TEC Glass™ is a glass coated with a fluorinated tin oxide conductive layer.

In some embodiments of the invention, the same conductive layer is used for both conductive layers (i.e., conductive layers). In some embodiments, different conductive materials are used for each conductive layers. For example, in some embodiments, TEC Glass™ is used for substrate (float glass) and conductive layer (fluorinated tin oxide) and indium tin oxide (ITO) is used for conductive layer. In some embodiments employing TEC Glass™ there is a sodium diffusion barrier between the glass substrate and TEC conductive layer. The function of the conductive layers is to spread an electric potential provided by voltage source 316 over surfaces of the electrochromic stack 320 to interior regions of the stack, with relatively little ohmic potential drop. The electric potential is transferred to the conductive layers though electrical connections to the conductive layers. In some embodiments, bus bars, one in contact with first conductive layer 304 and one in contact with second conductive layer 314, provide the electric connection between the voltage source 316 and the conductive layers 304 and 314. The conductive layers 304 and 314 may also be connected to the voltage source 316 with other conventional means.

Overlaying first conductive layer 304 is electrochromic layer 306. In some embodiments, electrochromic layer 306 is inorganic and/or solid. The electrochromic layer may contain any one or more of a number of different electrochromic materials, including metal oxides. Such metal oxides include tungsten oxide (WO₃), molybdenum oxide (MoO₃), niobium oxide (Nb₂O₅), titanium oxide (TiO₂), copper oxide (CuO), iridium oxide (Ir₂O₃), chromium oxide (Cr₂O₃), manganese oxide (Mn₂O₃), vanadium oxide (V₂O₅), nickel oxide (Ni₂O₃), cobalt oxide (Co₂O₃) and the like. During operation, electrochromic layer 306 transfers ions to and receives ions from counter electrode layer 310 to cause optical transitions.

Generally, the colorization (or change in any optical property—e.g., absorbance, reflectance, and transmittance) of the electrochromic material is caused by reversible ion insertion into the material (e.g., intercalation) and a corresponding injection of a charge balancing electron. Typically some fraction of the ions responsible for the optical transition is irreversibly bound up in the electrochromic material. Some or all of the irreversibly bound ions are used to compensate “blind charge” in the material. In most electrochromic materials, suitable ions include lithium ions (Li+) and hydrogen ions (H+) (that is, protons). In some cases, however, other ions will be suitable. In various embodiments, lithium ions are used to produce the electrochromic phenomena. Intercalation of lithium ions into tungsten oxide (WO_{3-y}(0<y≤˜0.3)) causes the tungsten oxide to change from transparent (bleached state) to blue (colored state).

Referring again to FIG. 3A, in electrochromic stack 320, ion conducting layer 308 is sandwiched between electrochromic layer 306 and counter electrode layer 310. In some embodiments, counter electrode layer 310 is inorganic and/or solid. The counter electrode layer may include one or more of a number of different materials that serve as a reservoir of ions when the electrochromic device is in the bleached state. During an electrochromic transition initiated by, for example, application of an appropriate electric potential, the counter electrode layer transfers some or all of the ions it holds to the electrochromic layer, changing the electrochromic layer to the colored state. Concurrently, in the case of NiWO, the counter electrode layer colors with the loss of ions.

In some embodiments, suitable materials for the counter electrode complementary to WO₃ include nickel oxide (NiO), nickel tungsten oxide (NiWO), nickel vanadium oxide, nickel chromium oxide, nickel aluminum oxide, nickel manganese oxide, nickel magnesium oxide, chromium oxide (Cr₂O₃), manganese oxide (MnO₂), and Prussian blue.

When charge is removed from a counter electrode layer 310 made of nickel tungsten oxide (that is, ions are transported from counter electrode layer 310 to electrochromic layer 306), the counter electrode layer will transition from a transparent state to a colored state.

In the depicted electrochromic device, between electrochromic layer 306 and counter electrode layer 310, there is the ion conducting layer 308. Ion conducting layer 308 serves as a medium through which ions are transported (in the manner of an electrolyte) when the electrochromic device transitions between the bleached state and the colored state. Preferably, ion conducting layer 308 is highly conductive to the relevant ions for the electrochromic and the counter electrode layers, but has sufficiently low electron conductivity that negligible electron transfer takes place during normal operation. A thin ion conducting layer with high ionic conductivity permits fast ion conduction and hence fast switching for high performance electrochromic devices. In certain embodiments, the ion conducting layer 308 is inorganic and/or solid.

Examples of suitable ion conducting layers (for electrochromic devices having a distinct IC layer) include silicates, silicon oxides, tungsten oxides, tantalum oxides, niobium oxides, and borates. These materials may be doped with different dopants, including lithium. Lithium doped silicon oxides include lithium silicon-aluminum-oxide. In some embodiments, the ion conducting layer includes a silicate-based structure. In some embodiments, a silicon-aluminum-oxide (SiAlO) is used for the ion conducting layer 308.

Electrochromic device 300 may include one or more additional layers (not shown), such as one or more passive layers. Passive layers used to improve certain optical properties may be included in electrochromic device 300. Passive layers for providing moisture or scratch resistance may also be included in electrochromic device 300. For example, the conductive layers may be treated with anti-reflective or protective oxide or nitride layers. Other passive layers may serve to hermetically seal electrochromic device 300.

FIG. 3B is a schematic cross-section of an electrochromic device in a bleached state (or transitioning to a bleached state). In accordance with specific embodiments, an electrochromic device 400 includes a tungsten oxide electrochromic layer (EC) 406 and a nickel-tungsten oxide counter electrode layer (CE) 410. Electrochromic device 400 also includes a substrate 402, a conductive layer (CL) 404, an ion conducting layer (IC) 408, and conductive layer (CL) 414.

A power source 416 is configured to apply a potential and/or current to an electrochromic stack 420 through suitable connections (e.g., bus bars) to the conductive layers 404 and 414. In some embodiments, the voltage source is configured to apply a potential of a few volts in order to drive a transition of the device from one optical state to another. The polarity of the potential as shown in FIG. 3B is such that the ions (lithium ions in this example) primarily reside (as indicated by the dashed arrow) in nickel-tungsten oxide counter electrode layer 410

FIG. 3C is a schematic cross-section of electrochromic device 400 shown in FIG. 3B but in a colored state (or transitioning to a colored state). In FIG. 3C, the polarity of power source 416 is reversed, so that the electrochromic layer is made more positive to accept additional lithium ions, and thereby transition to the colored state. As indicated by the dashed arrow, lithium ions are transported across ion conducting layer 408 to tungsten oxide electrochromic layer 406. Tungsten oxide electrochromic layer 406 is shown in the colored state. Nickel-tungsten oxide counter electrode layer 410 is also shown in the colored state. As explained, nickel-tungsten oxide becomes progressively more opaque as it gives up (deintercalates) lithium ions. In this example, there is a synergistic effect where the transition to colored states for both layers 406 and 410 are additive toward reducing the amount of light transmitted through the stack and substrate.

As described above, an electrochromic device may include an electrochromic (EC) layer and a counter electrode (CE) layer separated by an ionically conductive (IC) layer that is highly conductive to ions and highly resistive to electrons. As conventionally understood, the ionically conductive layer therefore prevents shorting between the electrochromic layer and the counter electrode layer. The ionically conductive layer allows the electrochromic and counter electrode layers to hold a charge and thereby maintain their bleached or colored states. In electrochromic devices having distinct layers, the components form a stack which includes the ion conducting layer sandwiched between the electrochromic electrode layer and the counter electrode layer. The boundaries between these three stack components are defined by abrupt changes in composition and/or microstructure. Thus, the devices have three distinct layers with two abrupt interfaces.

In accordance with certain embodiments, the counter electrode and electrochromic layers are formed immediately adjacent one another, sometimes in direct contact, without separately depositing an ionically conducting layer. In some embodiments, electrochromic devices having an interfacial region rather than a distinct IC layer are employed. Such devices, and methods of fabricating them, are described in U.S. Pat. No. 8,300,298 and U.S. patent application Ser. No. 12/772,075 filed on Apr. 30, 2010, and U.S. patent applications Ser. Nos. 12/814,277 and 12/814,279, filed on Jun. 11, 2010—each of the three patent applications and patent is entitled “Electrochromic Devices,” each names Zhongchun Wang et al. as inventors, and each is incorporated by reference herein in its entirety.

### B. Integrated Antennas

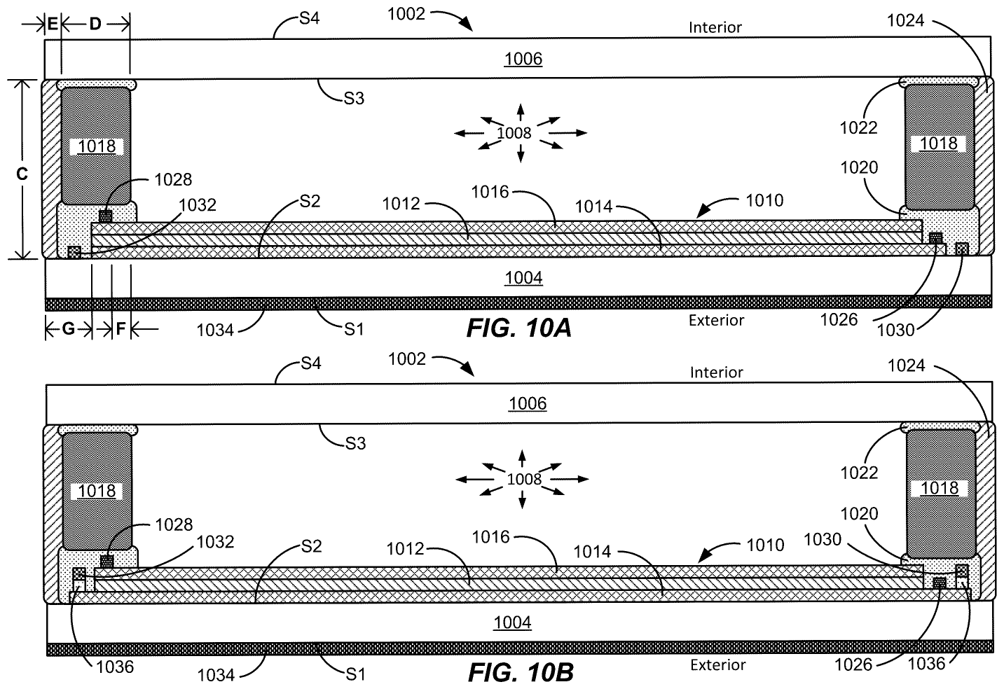

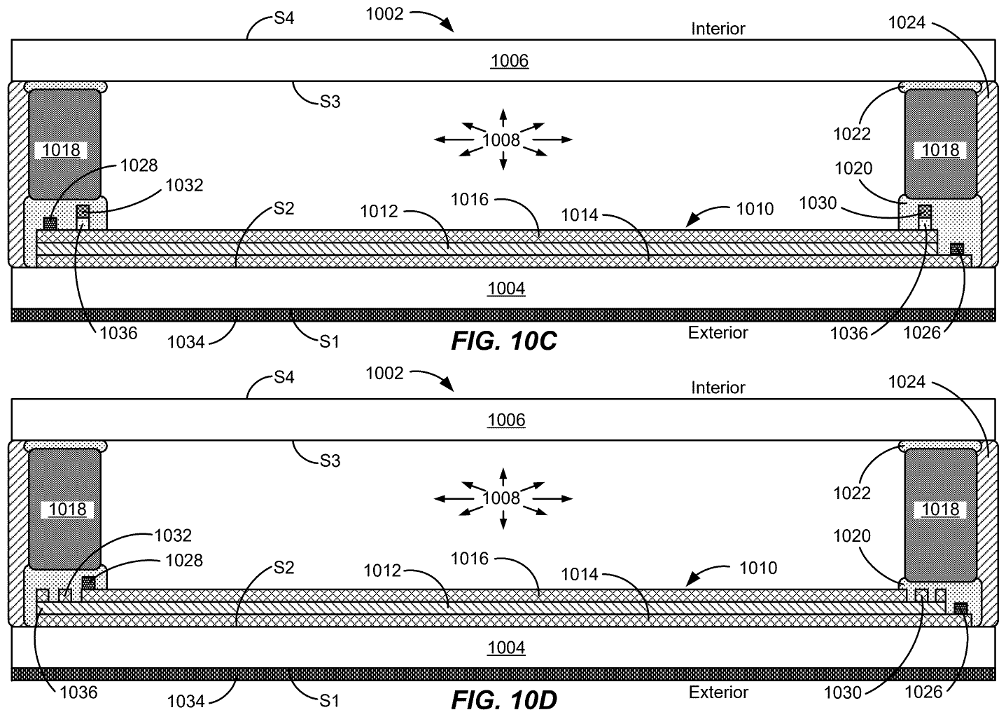

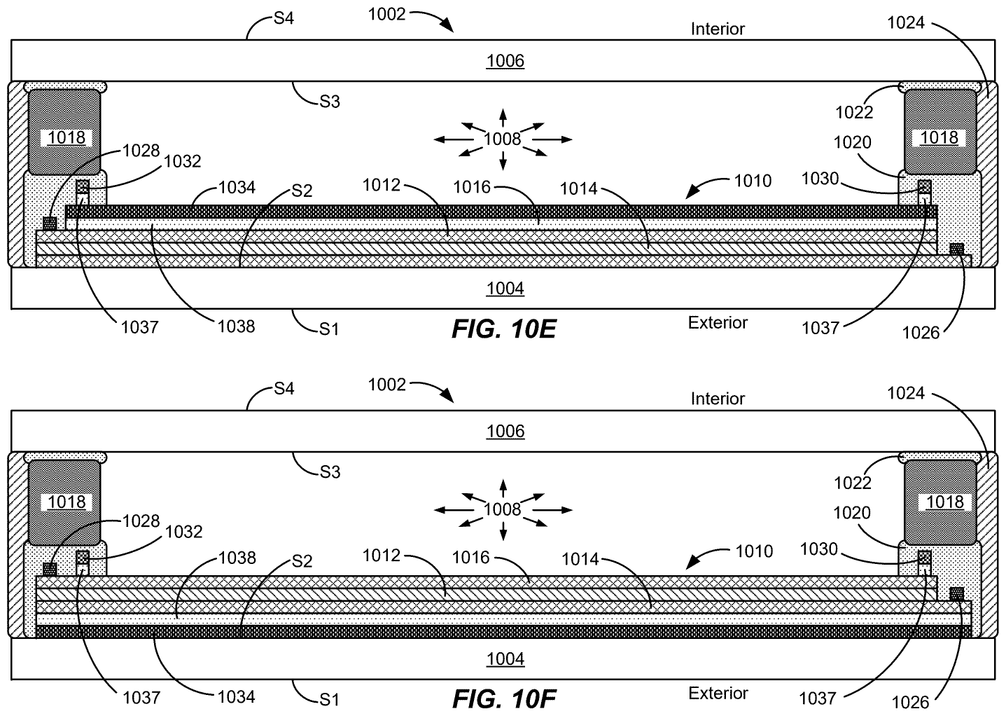

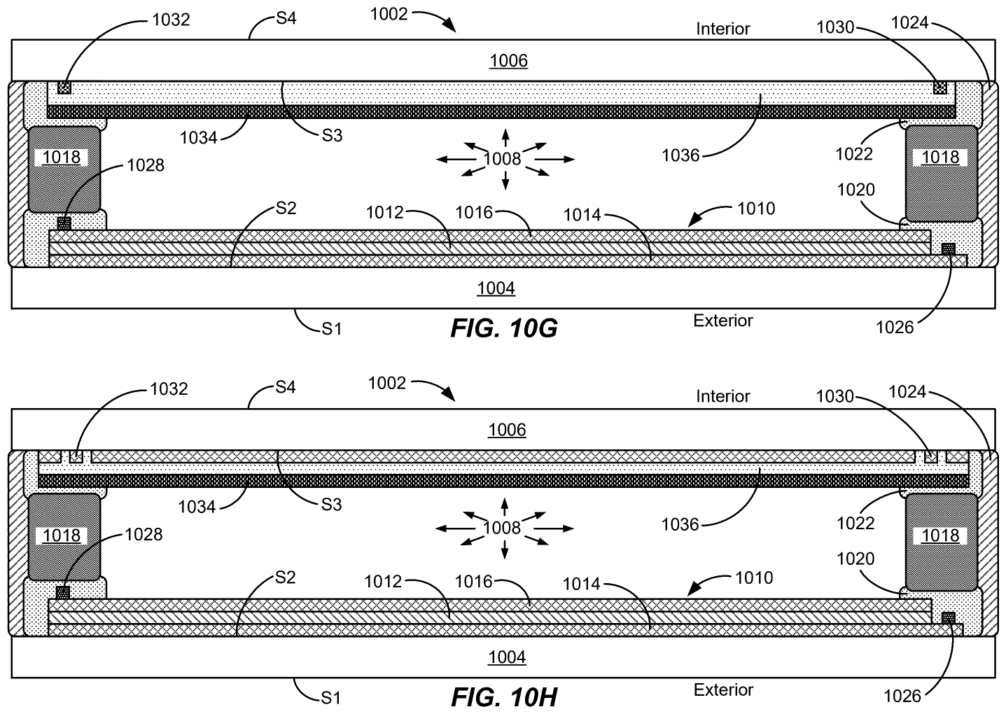

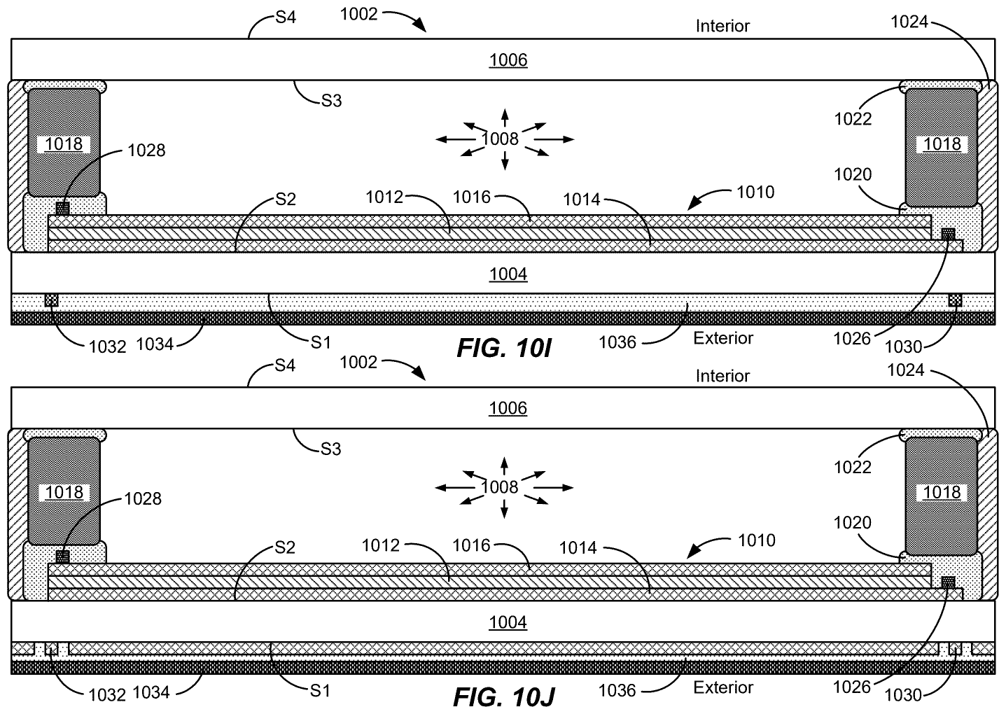

FIGS. 10A-10J show cross-sectional views of example electrochromic window structures with integrated antennas capable of transmitting signals into, or receiving signals from, an interior environment according to some implementations. Alternatively or in addition, in similar embodiments the integrated antennas may be capable of transmitting signals to, or receiving signals from, an exterior environment. In various embodiments herein, such integrated antennas may be used to receive and/or transmit a signal during the course of commissioning a network of electrochromic windows, as described further below.

The examples in FIGS. 10A-10J present a small subset of the available electrochromic IGU and electrochromic lite structures within the scope of this disclosure, so they should not be considered limiting in any way. Generally, the embodiments of FIGS. 10A-10J are similar to the embodiments shown in the preceding figures, further modified to include at least one integrated antenna. Details provided above with respect to the preceding figures and embodiments may also apply to the embodiments shown in FIGS. 10A-10J. Each of the example electrochromic window structures shown and described with respect to these and the following figures can be configured as an IGU and will hereinafter be referred to as an IGU 1002. FIG. 10A more particularly shows an example implementation of an IGU 1002 that includes a first pane (also referred to herein as a “lite”) 1004 having a first surface S1 and a second surface S2. In some implementations, the first surface S1 of the first pane 1004 faces an exterior environment, such as an outdoors or outside environment. The IGU 1002 also includes a second pane 1006 having a first surface S3 and a second surface S4. In some implementations, the second surface S4 of the second pane 1006 faces an interior environment, such as an inside environment of a home, building or vehicle, or a room or compartment within a home, building or vehicle.

In some implementations, each of the first and the second panes 1004 and 1006 are transparent or translucent at least to light in the visible spectrum. For example, each of the first and second panes 1004 and 1006 can be formed of a glass material and especially an architectural glass or other shatter-resistant glass material such as, for example, a silicon oxide (SOₓ)-based glass material. As a more specific example, each of the first and the second panes 1004 and 1006 can be a soda-lime glass substrate or float glass substrate. Such glass substrates can be composed of, for example, approximately 75% silica (SiO₂) as well as Na₂O, CaO, and several minor additives. However, each of the first and the second panes 1004 and 1006 can be formed of any material having suitable optical, electrical, thermal, and mechanical properties. For example, other suitable substrates that can be used as one or both of the first and the second panes 1004 and 1006 can include other glass materials as well as plastic, semi-plastic and thermoplastic materials (for example, poly(methyl methacrylate), polystyrene, polycarbonate, allyl diglycol carbonate, SAN (styrene acrylonitrile copolymer), poly(4-methyl-1-pentene), polyester, polyamide), or mirror materials. In some implementations, each of the first and the second panes 1004 and 1006 can be strengthened, for example, by tempering, heating, or chemically strengthening.

Generally, each of the first and the second panes 1004 and 1006, and the IGU 1002 as a whole, is a rectangular solid. However, in some other implementations other shapes (for example, circular, elliptical, triangular, curvilinear, convex, concave) are possible and may be desired. In some specific implementations, a length “L” of each of the first and the second panes 1004 and 1006 can be in the range of approximately 20 inches (in.) to approximately 10 feet (ft.), a width “W” of each of the first and the second panes 1004 and 1006 can be in the range of approximately 20 in. to approximately 10 ft., and a thickness “T” of each of the first and the second panes 1004 and 1006 can be in the range of approximately 1 millimeter (mm) to approximately 10 mm (although other lengths, widths or thicknesses, both smaller and larger, are possible and may be desirable based on the needs of a particular user, manager, administrator, builder, architect or owner). Additionally, while the IGU 1002 includes two panes (first pane 1004 and second pane 1006), in some other implementations, an IGU can include three or more panes. Furthermore, in some implementations, one or more of the panes can itself be a laminate structure of two, three, or more layers or sub-panes.

The first and second panes 1004 and 1006 are spaced apart from one another by spacers 1018 to form an interior volume 1008. In some implementations, the interior volume is filled with Argon (Ar), although in some other implementations, the interior volume 1008 can be filled with another gas, such as another noble gas (for example, krypton (Kr) or xenon (Xn)), another (non-noble) gas, or a mixture of gases (for example, air). Filling the interior volume 1008 with a gas such as Ar, Kr, or Xn can reduce conductive heat transfer through the IGU 1002 because of the low thermal conductivity of these gases as well as improve acoustic insulation due to their increased atomic weights. In some other implementations, the interior volume 1008 can be evacuated of air or other gas. The spacers 1018 generally determine the thickness of the interior volume 1008; that is, the spacing between the first and the second panes 1004 and 1006. In some implementations, the spacing “C” between the first and the second panes 1004 and 1006 is in the range of approximately 6 mm to approximately 30 mm. The width “D” of the spacers 1018 can be in the range of approximately 5 mm to approximately 15 mm (although other widths are possible and may be desirable).

Although not shown in the cross-sectional view, the spacers 1018 can be formed around all sides of the IGU 1002 (for example, top, bottom, left and right sides of the IGU 1002). For example, the spacers 1018 can be formed of a foam or plastic material. However, in some other implementations, the spacers can be formed of metal or other conductive material, for example, a metal tube structure. A first primary seal 1020 adheres and hermetically seals each of the spacers 1018 and the second surface S2 of the first pane 1004. A second primary seal 1022 adheres and hermetically seals each of the spacers 1018 and the first surface S3 of the second pane 1006. In some implementations, each of the first and second primary seals 1020 and 1022 can be formed of an adhesive sealant such as, for example, polyisobutylene (PIB). In some implementations, the IGU 1002 further includes secondary seal 1024 that hermetically seals a border around the entire IGU 1002 outside of the spacers 1018. To this end, the spacers 1018 can be inset from the edges of the first and the second panes 1004 and 1006 by a distance “E.” The distance “E” can be in the range of approximately 4 mm to approximately 8 mm (although other distances are possible and may be desirable). In some implementations, the secondary seal 1024 can be formed of an adhesive sealant such as, for example, a polymeric material that resists water and that adds structural support to the assembly.

In the implementation shown in FIG. 10A, an electrochromic (EC) device (ECD) 1010 is formed on the second surface S2 of the first pane 1004. As will be described below, in some other implementations, the ECD 1010 can be formed on another suitable surface, for example, the first surface S1 of the first pane, the first surface S3 of the second pane 1006 or the second surface S4 of the second pane 1006. Examples of electrochromic devices are presented in, e.g., U.S. Pat. No. 8,243,357, filed May 11, 2011, U.S. Pat. No. 8,764,951, filed Jun. 11, 2010, and U.S. Pat. No. 9,007,674, filed Feb. 8, 2013, each incorporated herein by reference in its entirety. In FIG. 10A, the ECD 1010 includes an EC stack 1012, which itself includes a number of layers. For example, the EC stack 1012 can include an electrochromic layer, an ion-conducting layer, and a counter electrode layer. In some implementations, the electrochromic layer is formed of an inorganic solid material. The electrochromic layer can include or be formed of one or more of a number of electrochromic materials, including electrochemically-cathodic or electrochemically-anodic materials. For example, metal oxides suitable for use as the electrochromic layer can include tungsten oxide (WO₃), molybdenum oxide (MoO₃), niobium oxide (Nb₂O₅), titanium oxide (TiO₂), copper oxide (CuO), iridium oxide (Ir₂O₃), chromium oxide (Cr₂O₃), manganese oxide (Mn₂O₃), vanadium oxide (V₂O₅), nickel oxide (Ni₂O₃) and cobalt oxide (Co₂O₃), among other materials. In some implementations, the electrochromic layer can have a thickness in the range of approximately 0.05 μm to approximately 1 μm.

In some implementations, the counter electrode layer is formed of an inorganic solid material. The counter electrode layer can generally include one or more of a number of materials or material layers that can serve as a reservoir of ions when the EC device 1010 is in, for example, the transparent state. For example, suitable materials for the counter electrode layer can include nickel oxide (NiO), nickel tungsten oxide (NiWO), nickel vanadium oxide, nickel chromium oxide, nickel aluminum oxide, nickel manganese oxide, nickel magnesium oxide, chromium oxide (Cr₂O₃), manganese oxide (MnO₂), and Prussian blue. In some implementations, the counter electrode layer is a second electrochromic layer of opposite polarity as first electrochromic layer described above. For example, when the first electrochromic layer is formed from an electrochemically-cathodic material, the counter electrode layer can be formed of an electrochemically-anodic material. In some implementations, the counter electrode layer can have a thickness in the range of approximately 0.05 μm to approximately 1 μm.

In some implementations, the ion-conducting layer serves as a medium through which ions are transported (for example, in the manner of an electrolyte) when the EC stack 1012 transitions between optical states. In some implementations, the ion-conducting layer is highly conductive to the relevant ions for the electrochromic and the counter electrode layers, but also has sufficiently low electron conductivity such that negligible electron transfer occurs during normal operation. A thin ion-conducting layer with high ionic conductivity enables fast ion conduction and consequently fast switching for high performance EC devices 1010. In some implementations, the ion-conducting layer can have a thickness in the range of approximately 0.01 μm to approximately 1 μm. In some implementations, the ion-conducting layer also is an inorganic solid. For example, the ion-conducting layer can be formed from one or more silicates, silicon oxides (including silicon-aluminum-oxide), tungsten oxides (including lithium tungstate), tantalum oxides, niobium oxides and borates. These materials also can be doped with different dopants, including lithium; for example, lithium-doped silicon oxides include lithium silicon-aluminum-oxide.

In some other implementations, the electrochromic layer and the counter electrode layer are formed immediately adjacent one another, sometimes in direct contact, without an ion-conducting layer in between. For example, in some implementations, an interfacial region between the electrochromic layer and the counter electrode layer can be utilized rather than incorporating a distinct ion-conducting layer. A further description of suitable devices is found in U.S. Pat. No. 8,300,298, issued Oct. 30, 2012 and U.S. patent application Ser. No. 13/462,725, filed May 2, 2012, each incorporated herein by reference in its entirety. In some implementations, the EC stack 1012 also can include one or more additional layers such as one or more passive layers. For example, passive layers can be used to improve certain optical properties, to provide moisture or to provide scratch resistance. In some implementations, the first and the second TCO layers 1014 and 1016 can be treated with anti-reflective or protective oxide or nitride layers. Additionally, other passive layers also can serve to hermetically seal the EC stack 1012.

In some implementations, the choice of appropriate electrochromic and counter-electrode materials governs the relevant optical transitions. During operation, in response to a voltage generated across the thickness of electrochromic layer, the electrochromic layer transfers or exchanges ions to or from the counter-electrode layer resulting in the desired optical transitions in the electrochromic layer, and in some implementations, also resulting in an optical transition in the counter-electrode layer. In one more specific example, responsive to the application of an appropriate electric potential across a thickness of EC stack 1012, the counter electrode layer transfers all or a portion of the ions it holds to the electrochromic layer causing the optical transition in the electrochromic layer. In some such implementations, for example, when the counter electrode layer is formed from NiWO, the counter electrode layer also optically transitions with the loss of ions it has transferred to the electrochromic layer. When charge is removed from a counter electrode layer made of NiWO (that is, ions are transported from the counter electrode layer to the electrochromic layer), the counter electrode layer will transition in the opposite direction.

Also to be appreciated is that transitions between a bleached or transparent state and a colored or opaque state are but some examples, among many, of optical or electrochromic transitions that can be implemented. Such transitions include changes in reflectivity, polarization state, scattering density, and the like. Unless otherwise specified herein (including the foregoing discussion), whenever reference is made to a bleached-to-opaque transition (or to and from intermediate states in between), the corresponding device or process described encompasses other optical state transitions such as, for example, intermediate state transitions such as percent transmission (% T) to % T transitions, non-reflective to reflective transitions (or to and from intermediate states in between), bleached to colored transitions (or to and from intermediate states in between), and color to color transitions (or to and from intermediate states in between). Additionally, the term “bleached” may refer to an optically neutral state, for example, uncolored, transparent or translucent. Furthermore, unless specified otherwise herein, the “color” of an electrochromic transition is not limited to any particular wavelength or range of wavelengths.

Generally, the colorization or other optical transition of the electrochromic material in the electrochromic layer is caused by reversible ion insertion into the material (for example, intercalation) and a corresponding injection of charge-balancing electrons. Typically, some fraction of the ions responsible for the optical transition is irreversibly bound up in the electrochromic material. Some or all of the irreversibly bound ions can be used to compensate for “blind charge” in the material. In some implementations, suitable ions include lithium ions (Li+) and hydrogen ions (H+) (i.e., protons). In some other implementations, other ions can be suitable. Intercalation of lithium ions, for example, into tungsten oxide (WO_{3-y}(0<y≤˜0.3)) causes the tungsten oxide to change from a transparent state to a blue state.

In some implementations, the EC stack 1012 reversibly cycles between a transparent state and an opaque or tinted state. In some implementations, when the EC stack 1012 is in a transparent state, a potential is applied across the EC stack 1012 such that available ions in the stack reside primarily in the counter electrode layer. When the magnitude of the potential across the EC stack 1012 is reduced or when the polarity of the potential is reversed, ions are transported back across the ion conducting layer to the electrochromic layer causing the electrochromic material to transition to an opaque, tinted, or darker state. In some implementations, the electrochromic and counter electrode layers are complementary coloring layers. As one example of a complementary implementation, when or after ions are transferred into the counter electrode layer, the counter electrode layer is lightened or transparent, and similarly, when or after the ions are transferred out of the electrochromic layer, the electrochromic layer is lightened or transparent. Conversely, when the polarity is switched, or the potential is reduced, and the ions are transferred from the counter electrode layer into the electrochromic layer, both the counter electrode and the electrochromic layers darken or become colored.

In some other implementations, when the EC stack 1012 is in an opaque state, a potential is applied to the EC stack 1012 such that available ions in the stack reside primarily in the counter electrode layer. In such implementations, when the magnitude of the potential across the EC stack 1012 is reduced or its polarity reversed, the ions are transported back across the ion conducting layer to the electrochromic layer causing the electrochromic material to transition to a transparent or lighter state. The electrochromic and ion-conducting layers also can be complementary coloring layers.

The ECD 1010 also includes a first transparent conductive oxide (TCO) layer 1014 adjacent a first surface of the EC stack 1012 and a second TCO layer 1016 adjacent a second surface of the EC stack 1012. For example, the first TCO layer 1014 can be formed on the second surface S2, the EC stack 1012 can be formed on the first TCO layer 1014 and the second TCO layer 1016 can be formed on the EC stack 1012. In some implementations, the first and the second TCO layers 1014 and 1016 can be formed of one or more metal oxides and metal oxides doped with one or more metals. For example, some suitable metal oxides and doped metal oxides can include indium oxide, indium tin oxide (ITO), doped indium oxide, tin oxide, doped tin oxide, fluorinated tin oxide, zinc oxide, aluminum zinc oxide, doped zinc oxide, ruthenium oxide and doped ruthenium oxide, among others. While such materials are referred to as TCOs in this document, the term encompasses non-oxides as well as oxides that are transparent and electrically conductive such as certain thin metals and certain non-metallic materials such as conductive metal nitrides and composite conductors, among other suitable materials. In some implementations, the first and the second TCO layers 1014 and 1016 are substantially transparent at least in the range of wavelengths where electrochromism is exhibited by the EC stack 1012. In some implementations, the first and the second TCO layers 1014 and 1016 can each be deposited by physical vapor deposition (PVD) processes including, for example, sputtering. In some implementations, the first and the second TCO layers 1014 and 1016 can each have a thickness in the range of approximately 0.01 microns (μm) to approximately 1 μm. A transparent conductive material typically has an electronic conductivity significantly greater than that of the electrochromic material or the counter electrode material.

The first and the second TCO layers 1014 and 1016 serve to distribute electrical charge across respective first and second surfaces of the EC stack 1012 for applying an electrical potential (voltage) across the thickness of the EC stack 1012 to modify one or more optical properties (for example, a transmittance, absorbance, or reflectance) of the EC stack 1012 or layers within the EC stack 1012. Desirably, the first and the second TCO layers 1014 and 1016 serve to uniformly distribute electrical charge from outer surface regions of the EC stack 1012 to inner surface regions of the EC stack 1012 with relatively little Ohmic potential drop from the outer regions to the inner regions. As such, it is generally desirable to minimize the sheet resistance of the first and the second TCO layers 1014 and 1016. In other words, it is generally desirable that each of the first and the second TCO layers 1014 and 1016 behave as substantially equipotential layers across all portions of the respective first and second TCO layers 1014 and 1016. In this way, the first and the second TCO layers 1014 and 1016 can uniformly apply an electric potential across a thickness of the EC stack 1012 to effect a transition of the EC stack 1012 from a bleached or lighter state (for example, a transparent, semitransparent, or translucent state) to a colored or darker state (for example, a tinted, less transparent or less translucent state) and vice versa.

A first bus bar 1026 distributes a first electrical (for example, a voltage) signal to the first TCO layer 1014. A second bus bar 1028 distributes a second electrical (for example, a voltage) signal to the first TCO layer 1014. In some other implementations, one of the first and the second bus bars 1026 and 1028 can ground the respective one of the first and the second TCO layers 1014 and 1016. In the illustrated implementation, each of the first and the second bus bars 1026 and 1028 is printed, patterned, or otherwise formed such that it is oriented along a respective length of the first pane 1004 along a border of the EC stack 1012. In some implementations, each of the first and the second bus bars 1026 and 1028 is formed by depositing a conductive ink, for example, a silver ink, in the form of a line. In some implementations, each of the first and the second bus bars 1026 and 1028 extends along the entire length (or nearly the entire length) of the first pane 1004.

In the illustrated implementation, the first TCO layer 1014, the EC stack 1012 and the second TCO layer 1016 do not extend to the absolute edges of the first pane 1004. For example, in some implementations, a laser edge delete (LED) or other operation can be used to remove portions of the first TCO layer 1014, the EC stack 1012 and the second TCO layer 1016 such that these layers are separated or inset from the respective edges of the first pane 1004 by a distance “G,” which can be in the range of approximately 8 mm to approximately 10 mm (although other distances are possible and may be desirable). Additionally, in some implementations, an edge portion of the EC stack 1012 and the second TCO layer 1016 along one side of the first pane 2014 is removed to enable the first bus bar 1026 to be formed on the first TCO layer 1014 to enable conductive coupling between the first bus bar 1026 and the first TCO layer 1014. The second bus bar 1028 is formed on the second TCO layer 1016 to enable conductive coupling between the second bus bar 1028 and the second TCO layer 1016. In some implementations, the first and the second bus bars 1026 and 1028 are formed in a region between the respective spacers 1018 and the first pane 1004 as shown in FIG. 10A. For example, each of the first and the second bus bars 1026 and 1028 can be inset from an inner edge of the respective spacer 1018 by at least a distance “F,” which can be in the range of approximately 2 mm to approximately 3 mm (although other distances are possible and may be desirable). One reason for this arrangement is to hide the bus bars from view. A further description of bus bar positioning and LED is found in U.S. Patent Application No. 61/923,171, filed Jan. 2 2014, which is incorporated herein by reference in its entirety.

In the implementation shown in FIG. 10A, first and second antenna structures 1030 and 1032 are formed within the inset region defined by the distance G. In some implementations, each of the first and the second antenna structures 1030 and 1032 is configured as a strip line antenna. In some implementations, each of the first and the second antenna structures 1030 and 1032 is formed by depositing a conductive ink, for example, a silver ink, in the form of a line. In some other implementations, each of the first and the second antenna structures 1030 and 1032 can be formed by applying or adhering a conductive (for example, copper) foil or using suitable PVD or other deposition processes. In some other implementations, each of the first and the second antenna structures 1030 and 1032 is formed by patterning the first TCO layer 1014 to electrically isolate conductive strip lines. In some implementations, each of the first and the second antenna structures 1030 and 1032 extends along a portion of the length of the first pane 1004. The length of each of the first and the second antenna structures 1030 and 1032 is generally dictated by the wavelength of the respective signal the antenna structure is designed to transmit or receive. For example, the length of each of the first and the second antenna structures 1030 and 1032 can be equal to an integer number of quarter-wavelengths of the relevant signal. In some implementations, each of the first and the second antenna structures 1030 and 1032 has a width suitable for carrying signals of the desired frequencies, and a thickness suitable for carrying signals of the desired frequencies. In some implementations, the width and thickness of each of the first and the second antenna structures 1030 and 1032 may correspond to an integer multiple of a wavelength (or fraction thereof) of a signal to be carried by the antenna structure. In embodiments where the antenna structure occupies at least a portion of the visible region of a window lite, the lines defining the antenna structure may made sufficiently thin that they are not substantially visible to individuals looking through the IGU. The examples in FIGS. 10A-J J present a small subset of the available window antenna designs within the scope of this disclosure, so they should not be considered limiting in any way.

In some implementations, each of the first and the second antenna structures 1030 and 1032 can be individually-addressable or independently driven, as for example when each antenna is a monopole antenna. For example, each of the first and the second antenna structures 1030 and 1032 can be electrically connected via a conductive bus, line, or interconnect (hereinafter used interchangeably where appropriate) to the corresponding window controller or to another controller or device for transmitting signals to the first and the second antenna structures 1030 and 1032 or for receiving signals from the first and the second antenna structures 1030 and 1032. Additionally, in some implementations, each of the first and the second antenna structures 1030 and 1032 can have a different set of parameters than the other (for example, a different length, width or thickness depending on the relevant signal or signals to be transmitted or received). In some other implementations, the IGU 1002 can include only one of the first or second antenna structures 1030 and 1032 or more than the two antenna structures in addition to the first and second antenna structures 1030 and 1032. In some implementations, one of the antennas is set to receive signals and the other is set to transmit signals. In some implementations, the two antenna structures are driven in a complementary controlled fashion as when they are part of a dipole antenna.

In some embodiments, a ground plane and/or antenna structure is fabricated on the same surface as the electrochromic device. In one example, a combined ground plane and electrochromic device stack includes a flat continuous ground plane next to the glass substrate, an insulating layer next to that ground plane, the first transparent conductive layer of the electrochromic stack on top of the insulator, and the remainder of the electrochromic device on top of that transparent conductive layer. The electrochromic device stack may be fabricated per conventional fabrication procedures. In this approach, the lower ground plane could be the TEC (a fluorinated tin oxide) layer applied by certain glass manufacturers, or it could be applied by the electrochromic device manufacturer, or it could be a combination of the two. For example, existing TEC could be modified by the glass manufacturer to be thicker or to include a combination of the TEC from the manufacturer with a thin additional layer of transparent conductor placed on top of the TEC.

In some implementations, the IGU 1002 of FIG. 10A further includes a ground plane 1034 on the first surface S1 of the first pane 1004. The ground plane 1034 can function to make the first and second antenna structures 1030 and 1032 directional. For example, as described above, FIGS. 10A-10J show cross-sectional views of example IGUs 1002 with integrated antennas capable of transmitting signals into, or receiving signals from, an interior environment according to some implementations. As such, by forming or otherwise including a ground plane 1034 between the first and the second antenna structures 1030 and 1032 and the exterior environment, each of the first and the second antenna structures 1030 and 1032 can be so as to be directional with respect to the interior environment; that is, capable of transmitting signals into, or receiving signals from, only the interior environment. If such directionality is not needed or is not desired, the ground plane 1034 is not included. In some implementations, the ground plane 1034 can extend across substantially all of the surface S1 as shown. In some other implementations, the ground plane 1034 can extend only along and across regions of the surface S1 in proximity to the respective first and second antenna structures 1030 and 1032. In some implementations, the ground plane 1034 can be formed of a conductive material such as any of those described above, including thin film metals or metallic alloys as well as conductive oxides. Typically when the ground plane is in the viewable window area of an IGU, the ground plane has an optical transmissivity that does not significantly reduce an occupant's ability to see through the window when in a clear state.

FIG. 10B shows a cross-sectional view of another example IGU 1002 with integrated antennas capable of transmitting signals into, or receiving signals from, an interior environment according to some implementations. The IGU 1002 shown and described with reference to FIG. 10B is similar to the IGU 1002 shown and described with reference to FIG. 10A except for at least the difference that the first and the second antenna structures 1030 and 1032 are formed on respective edge regions of the first TCO layer 1014. To electrically insulate the first and the second antenna structures 1030 and 1032 from the first TCO layer 1014, a dielectric or other insulating material layer including an insulating material 1036 is provided on the first TCO layer 1014 under the first and the second antenna structures 1030 and 1032. In some embodiments, only one of the two antennas is provided on first TCO layer 1014. For example, second antenna structure 1032 may be provided directly on first pane 1004.

FIG. 10C shows a cross-sectional view of another example IGU 1002 with integrated antennas capable of transmitting signals into, or receiving signals from, an interior environment according to some implementations. The IGU 1002 shown and described with reference to FIG. 10C is similar to the IGU 1002 shown and described with reference to FIG. 10A except for at least the difference that the first and the second antenna structures 1030 and 1032 are formed on respective edge regions of the second TCO layer 1016. To electrically insulate the first and the second antenna structures 1030 and 1032 from the second TCO layer 1016, a dielectric or other insulating material layer including insulating material 1036 is provided on the second TCO layer 1016 under the first and the second antenna structures 1030 and 1032. In some embodiments, only one of the two antennas is provided on second TCO layer 1016. For example, first antenna structure 1030 may be provided directly on first pane 1004 or on first TCO layer 1014 (but separated therefrom by the layer of insulating 1036).

FIG. 10D shows a cross-sectional view of another example IGU 1002 with integrated antennas capable of transmitting signals into, or receiving signals from, an interior environment according to some implementations. The IGU 1002 shown and described with reference to FIG. 10D is similar to the IGU 1002 shown and described with reference to FIG. 10A except for at least the difference that the first and the second antenna structures 1030 and 1032 are formed by patterning the second TCO layer 1016. For example, one or more laser scribing, laser ablating or etching processes can be used to pattern the first and the second antenna structures 1030 and 1032 and to electrically insulate the first and the second antenna structures 1030 and 1032 from the surrounding portions of the second TCO layer 1016. In the depicted embodiment, first antenna structure 1030 includes two strip lines.

FIG. 10E shows a cross-sectional view of another example IGU 1002 with integrated antennas capable of transmitting signals into, or receiving signals from, an interior environment according to some implementations. The IGU 1002 shown and described with reference to FIG. 10E is similar to the IGU 1002 shown and described with reference to FIG. 10C except for at least the difference that the first and the second antenna structures 1030 and 1032 are formed on a ground plane 1034, which is, in turn, formed on the second TCO layer 1016. To electrically insulate the ground plane 1034 from the second TCO layer 1016, a dielectric or other insulating material layer 1038 is provided on the second TCO layer 1016 and under the ground plane 1034. Insulating strips 1037 isolate first and second antenna structures 1030 and 1032 from ground plane 1034.

FIG. 10F shows a cross-sectional view of another example IGU 1002 with integrated antennas capable of transmitting signals into, or receiving signals from, an interior environment according to some implementations. The IGU 1002 shown and described with reference to FIG. 10F is similar to the IGU 1002 shown and described with reference to FIG. 10E except for at least the difference that the ground plane 1034 is formed between the second surface S2 of the first pane 1004 and the EC device 1010. To electrically insulate the ground plane 1034 from the first TCO layer 1014, a dielectric or other insulating material layer 1038 is first formed on the ground plane 1034 before the formation of the first TCO layer 1014. In the depicted embodiments, first and second antenna structures 1030 and 1032, along with insulating strips 1037, reside on second TCO layer 1016. In other embodiments, one or both of the antenna structures reside on first TCO layer 1014.

FIG. 10G shows a cross-sectional view of another example IGU 1002 with integrated antennas capable of transmitting signals into, or receiving signals from, an interior environment according to some implementations. The IGU 1002 shown and described with reference to FIG. 10G is similar to the IGU 1002 shown and described with reference to FIG. 10A except for at least the difference that the first and the second antenna structures 1030 and 1032 are formed on respective edge regions of the first surface S3 of the second pane 1006. In some cases, the antenna structures are formed by printing conductive materials such as silver ink. In some implementations, the IGU 1002 of FIG. 10G further includes a ground plane 1034 disposed over the first and the second antenna structures 1030 and 1032. To electrically insulate the ground plane 1034 from the first and the second antenna structures 1030 and 1032, a dielectric or other insulating material layer 1036 is first formed over the first and the second antenna structures 1030 and 1032 before the formation of the ground plane 1034. In some other implementations, the ground plane 1034 can be disposed on the first surface S1 of the first pane 1004 or on the second surface S2 of the first pane 1004 under or over the EC device 1010.

FIG. 10H shows a cross-sectional view of another example IGU 1002 with integrated antennas capable of transmitting signals into, or receiving signals from, an interior environment according to some implementations. The IGU 1002 shown and described with reference to FIG. 10H is similar to the IGU 1002 shown and described with reference to FIG. 10G except for at least the difference that the first and the second antenna structures 1030 and 1032 are patterned from a conductive oxide layer (for example, such as the same material as the first and second TCO layers 1014 and 1016).

FIG. 10I shows a cross-sectional view of another example IGU 1002 with integrated antennas capable of transmitting signals into, or receiving signals from, an interior environment according to some implementations. The IGU 1002 shown and described with reference to FIG. 10I is similar to the IGU 1002 shown and described with reference to FIG. 10G except for at least the difference that the first and the second antenna structures 1030 and 1032 are formed on respective edge regions of the first surface S1 of the first pane 1004. In some cases, the antenna structures are conductive strips such as silver ink strips. In some implementations, the IGU 1002 of FIG. 10I further includes a ground plane 1034 formed over the first and the second antenna structures 1030 and 1032. To electrically insulate the ground plane 1034 from the first and the second antenna structures 1030 and 1032, a dielectric or other insulating material layer 1036 is first formed over the first and the second antenna structures 1030 and 1032 before the formation of the ground plane 1034.

FIG. 10J shows a cross-sectional view of another example IGU 1002 with integrated antennas capable of transmitting signals into, or receiving signals from, an interior environment according to some implementations. The IGU 1002 shown and described with reference to FIG. 10J is similar to the IGU 1002 shown and described with reference to FIG. 10I except for at least the difference that the first and the second antenna structures 1030 and 1032 are patterned from a conductive oxide layer (for example, such as the same material as the first and second TCO layers 1014 and 1016).

### C. Window Controllers

A window controller may be used to control tinting of a tintable window. For example, a window controller in communication may be utilized to adjust the tint level, and associated transmissivity, of an electrochromic window. In some embodiments, the window controller is able to transition the electrochromic window between multiple tint states (levels) including a bleached state and a colored state. In one aspect, a window controller is able to transition an electrochromic window to any one of four tint levels (including the bleached state and the colored state). In another aspect, a window controller is able to transition an electrochromic window to any one of four or more tint levels.

In some embodiments, an electrochromic window can include an electrochromic device (e.g., electrochromic device 400) on one lite of an IGU (e.g., IGU 200) and another electrochromic device (e.g., electrochromic device 400) on the other lite of the IGU. If the window controller is able to transition each electrochromic device between two states, a bleached state and a colored state, the electrochromic window is able to attain four different states (tint levels), a colored state with both electrochromic devices being colored, a first intermediate state with one electrochromic device being colored, a second intermediate state with the other electrochromic device being colored, and a bleached state with both electrochromic devices being bleached. Embodiments of multi-pane electrochromic windows are further described in U.S. Pat. No. 8,270,059, naming Robin Friedman et al. as inventors, titled “MULTI-PANE ELECTROCHROMIC WINDOWS,” which is hereby incorporated by reference in its entirety.

In some embodiments, the window controller is able to transition an electrochromic window having an electrochromic device capable of transitioning between two or more tint levels. For example, a window controller may be able to transition the electrochromic window to a bleached state, one or more intermediate levels, and a colored state. In some other embodiments, the window controller is able to transition an electrochromic window incorporating an electrochromic device between any number of tint levels between the bleached state and the colored state. Embodiments of methods and controllers for transitioning an electrochromic window to an intermediate tint level or levels are further described in U.S. Pat. No. 8,254,013, naming Disha Mehtani et al. as inventors, titled “CONTROLLING TRANSITIONS IN OPTICALLY SWITCHABLE DEVICES,” which is hereby incorporated by reference in its entirety.

In some embodiments, a window controller can power one or more electrochromic devices in an electrochromic window. Typically, this function of the window controller is augmented with one or more other functions described in more detail below. Window controllers described herein are not limited to those that have the function of powering an electrochromic device to which it is associated for the purposes of control. That is, the power source for the electrochromic window may be separate from the window controller, where the controller has its own power source and directs application of power from the window power source to the window. However, it is convenient to include a power source with the window controller and to configure the controller to power the window directly, because it obviates the need for separate wiring for powering the electrochromic window.

Further, the window controllers described in this section are described as standalone controllers which may be configured to control the functions of a single window or a plurality of electrochromic windows, without integration of the window controller into a building control network or a building management system (BMS). Window controllers, however, may be integrated into a building control network or a BMS.

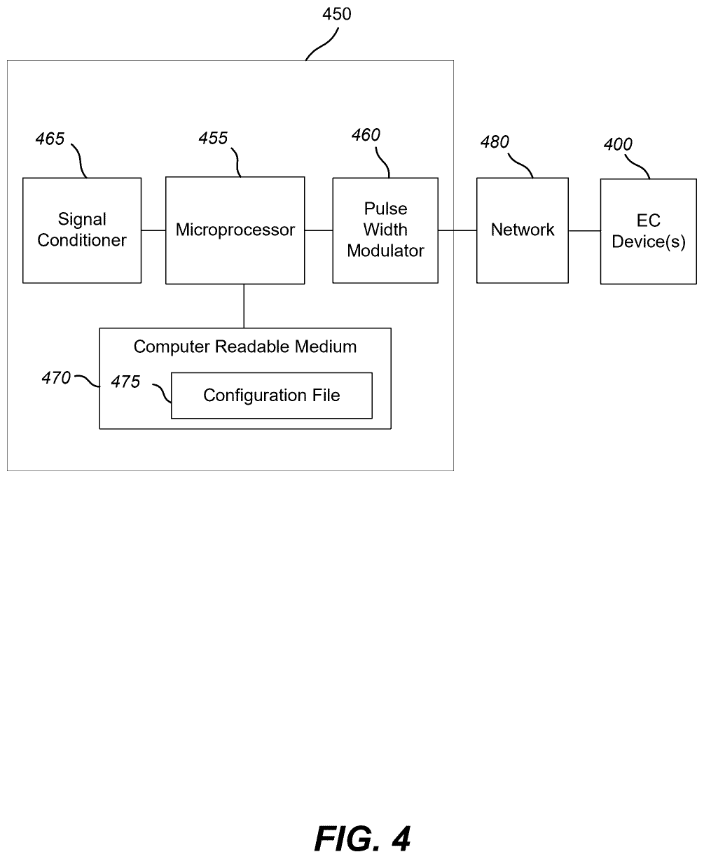

FIG. 4 depicts a simplified block diagram of some components of a window controller 450 and other components of a window controller system of disclosed embodiments. More detail of components of window controllers can be found in U.S. patent application Ser. Nos. 13/449,248 and 13/449,251, both naming Stephen Brown as inventor, both titled “CONTROLLER FOR OPTICALLY-SWITCHABLE WINDOWS,” and both filed on Apr. 17, 2012, and in U.S. patent Ser. No. 13/449,235, titled “CONTROLLING TRANSITIONS IN OPTICALLY SWITCHABLE DEVICES,” naming Stephen Brown et al. as inventors and filed on Apr. 17, 2012, all of which are hereby incorporated by reference in their entireties.

In FIG. 4, the illustrated components of the window controller 450 include a microprocessor 455 or other processor, a pulse width modulator (PWM) 460, one or more input 465, and a computer readable medium 470 (e.g., memory) having a configuration file 475. Window controller 450 is in electronic communication with one or more electrochromic devices 400 in an electrochromic window through network 480 (wired or wireless) to send instructions to the one or more electrochromic devices 400. In some embodiments, the window controller 450 may be a local window controller in communication through a network (wired or wireless) to a master window controller.

In disclosed embodiments, window controller 450 can instruct the PWM 460, to apply a voltage and/or current to an electrochromic window to transition it to any one of four or more different tint levels. In disclosed embodiments, an electrochromic window can be transitioned to at least eight different tint levels described as: 0 (lightest), 5, 10, 15, 20, 25, 30, and 35 (darkest). The tint levels may linearly correspond to visual transmittance values and solar heat gain coefficient (SHGC) values of light transmitted through the electrochromic window. For example, using the above eight tint levels, the lightest tint level of 0 may correspond to an SHGC value of 0.80, the tint level of 5 may correspond to an SHGC value of 0.70, the tint level of 10 may correspond to an SHGC value of 0.60, the tint level of 15 may correspond to an SHGC value of 0.50, the tint level of 20 may correspond to an SHGC value of 0.40, the tint level of 25 may correspond to an SHGC value of 0.30, the tint level of 30 may correspond to an SHGC value of 0.20, and the tint level of 35 (darkest) may correspond to an SHGC value of 0.10.

Window controller 450 or a master controller in communication with the window controller 450 may employ any one or more control logic components to determine a desired tint level based on signals from an exterior sensor and/or other input. The window controller 450 can instruct the PWM 460 to apply a voltage and/or current to the electrochromic window to transition it to the desired tint level.

It should be understood that control logic and other logic used to implement techniques described above can be implemented in the form of circuits, processors (including general purpose microprocessors, digital signal processors, application specific integrated circuits, programmable logic such as field-programmable gate arrays, etc.), computers, computer software, devices such as sensors, or combinations thereof. Based on the disclosure and teachings provided herein, a person of ordinary skill in the art will know and appreciate other ways and/or methods to implement the disclosed techniques using hardware and/or a combination of hardware and software.

Any of the components or functions of software, firmware, or machine-instructions described in this application, may be implemented as code to be executed by a processor using any suitable computer language such as, for example, Java, C++ or Python using, for example, conventional or object-oriented techniques. The code may be stored as a series of instructions, or commands on a computer or machine readable medium, such as a random-access memory (RAM), a read only memory (ROM), a programmable memory (EEPROM), a magnetic medium such as a hard-drive or a floppy disk, or an optical medium such as a CD-ROM. Any such computer or machine readable medium may reside on or within a single computational apparatus, and may be present on or within different computational apparatuses within a system or network. In some implementations, the computer or machine readable medium is a non-transitory medium.

In some embodiments disclosed herein, one or more electrochromic devices are operatively coupled to at least one controller and/or processor. A controller may comprise a processing unit (e.g., CPU or GPU). A controller may receive an input (e.g., from at least one device or projected media). The controller may comprise circuitry, electrical wiring, optical wiring, socket, and/or outlet. A controller may receive an input and/or deliver an output. A controller may comprise multiple (e.g., sub-) controllers. An operation (e.g., as disclosed herein) may be performed by a single controller or by a plurality of controllers. At least two operations may be each preconformed by a different controller. At least two operations may be preconformed by the same controller. A device and/or media may be controlled by a single controller or by a plurality of controllers. At least two devices and/or media may be controlled by a different controller. At least two devices and/or media may be controlled by the same controller. The controller may be a part of a control system. The control system may comprise a master controller, floor (e.g., comprising network controller) controller, or a local controller. The local controller may be a target controller. For example, the local controller may be a window controller (e.g., controlling an tintable window), enclosure controller, or component controller. The controller may be a part of a hierarchal control system. The hierarchal control system may comprise a main controller that directs one or more controllers, e.g., floor controllers, local controllers (e.g., window controllers), enclosure controllers, and/or component controllers. The target may comprise a device or a media. The device may comprise an electrochromic window, a sensor, an emitter, an antenna, a receiver, a transceiver, or an actuator.

In some examples, a controlled apparatus is a tintable window (e.g., an electrochromic window). In some embodiments, a dynamic state of an electrochromic window is controlled by altering a voltage signal to an electrochromic device (ECD) used to provide tinting or coloring. An electrochromic window can be manufactured, configured, or otherwise provided as an insulated glass unit (IGU). IGUs may serve as the fundamental constructs for holding electrochromic panes (also referred to as “lites”) when provided for installation in a building. An IGU lite or pane may be a single substrate or a multi-substrate construct, such as a laminate of two substrates.

The controller may be implemented in an electronic device in various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital assistant, a cellular telephone, a smart phone, a wearable device and other similar computing apparatuses. The parts shown herein, their connections and relationships, and their functions are only as examples, and not intended to limit implementations of the present disclosure as described and/or claimed herein.

In some implementations, the controller is coupled to memory, such as a non-transitory computer-readable or machine-readable medium. The memory stores instructions for the controller to operate a ECD using methods disclosed herein. In some implementations, the controller comprises a processor. The memory, as a non-transitory computer readable storage medium, may be used to store non-transitory software programs, non-transitory computer executable programs and modules, such as program instructions/modules corresponding to the method for controlling an ECD in the embodiments of the present disclosure. The processor executes the non-transitory software programs, instructions, and modules stored in the memory to execute various functional applications and data processing.

The memory may include a storage program area and a storage data area, where the storage program area may store an operating system and at least one function required application program; and the storage data area may store data created by the use of the electronic device according to the disclosed methods. In addition, the memory may include a high-speed random access memory, and may also include a non-transitory memory, such as at least one magnetic disk storage device, a flash memory device, or other non-transitory solid-state storage devices. In some embodiments, the memory may optionally include memories remotely provided with respect to the processor, and these remote memories may be connected to the electronic device of the method for controller the ECD. Examples of the above network include but are not limited to the Internet, intranet, local area network, mobile communication network, and combinations thereof.

Examples of tintable windows, window controllers, their methods of use and their features are presented in U.S. patent application Ser. No. 15/334,832, filed Oct. 26, 2016, titled “CONTROLLERS FOR OPTICALLY-SWITCHABLE DEVICES,” and U.S. patent application Ser. No. 16/082,793, filed Sep. 6, 2018, titled “METHOD OF COMMISSIONING ELECTROCHROMIC WINDOWS,” each of which is herein incorporated by reference in its entirety.

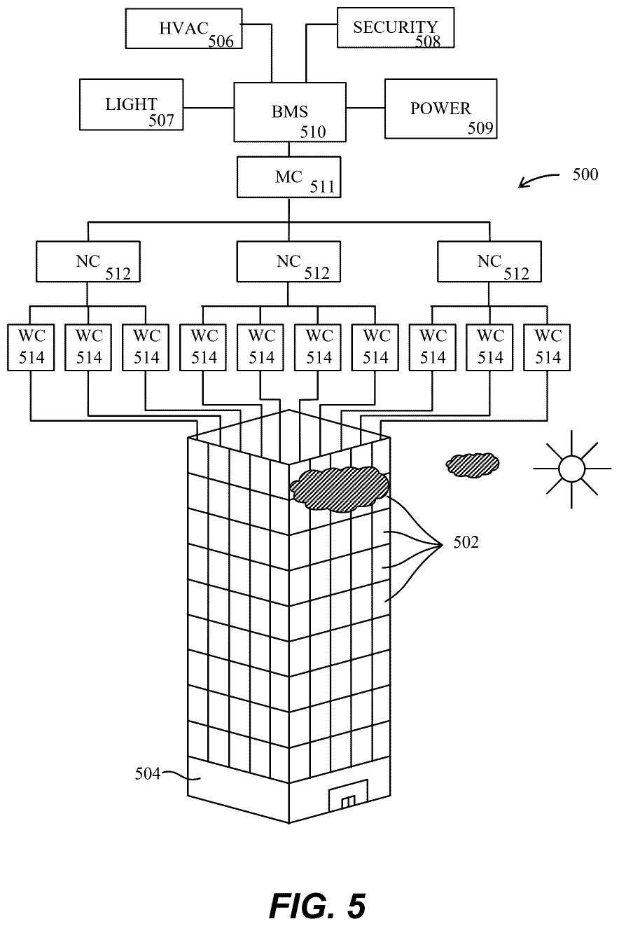

FIG. 5 is a schematic depiction of a system 500 for controlling and driving a plurality of electrochromic windows 502 of a building 504. It may be employed to control the operation of one or more devices associated with a tintable window such as a window antenna. The system 500 can be adapted for use with facility (e.g., a building 504) comprising a commercial office building or a residential building. In this example, the system 500 is designed to function in conjunction with modern heating, ventilation, and air conditioning (HVAC) systems 506, interior lighting systems 507, security systems 508, and power systems 509 as a single holistic and efficient energy control system for the entire building 504, or a campus of buildings 504. The system 500 also includes a building management system (BMS) 510. The BMS 510 is a computer-based control system that can be installed in a building to monitor and control the building's mechanical and electrical equipment such as HVAC systems, lighting systems, power systems, elevators, fire systems, and security systems. The BMS 510 can include hardware and associated firmware or software for maintaining conditions in the building 504 according to preferences set by the occupants or by a building manager or other administrator. The software can be based on, for example, internet protocols or open standards.

A BMS can be used in large buildings where it functions to control the environment within the building. For example, the BMS 510 may control lighting, temperature, carbon dioxide levels, and/or humidity within the building 504. There can be several (e.g., numerous) mechanical and/or electrical devices that are controlled by the BMS 510 including, for example, furnaces or other heaters, air conditioners, blowers, and/or vents. To control the building environment, the BMS 510 can turn on and off these various devices, e.g., according to rules and/or in response to conditions. Such rules and/or conditions may be selected and/or specified by a user (e.g., building manager and/or administrator). One function of the BMS 510 may be to maintain a comfortable environment for the occupants of the building 504, e.g., while minimizing heating and cooling energy losses and costs. In some embodiments, the BMS 510 is configured not (e.g., only) to monitor and control, but also to optimize the synergy between various systems, for example, to conserve energy and lower building operation costs.

Some embodiments are designed to function responsively or reactively based on feedback. The feedback control scheme may comprise measurements sensed through, for example, thermal, optical, or other sensors. The feedback control scheme may comprise input from an HVAC, interior lighting system, and/or an input from a user control. Examples of control system, methods of its use, and its related software, may be found in U.S. Pat. No. 8,705,162, issued Apr. 22, 2014, which is incorporated herein by reference in its entirety. Some embodiments are utilized in existing structures, including commercial and/or residential structures, e.g., having traditional or conventional HVAC and/or interior lighting systems. Some embodiments are retrofitted for use in older facilities (e.g., residential homes).

The system 500 includes network controllers (NCs) 512 configured to control a plurality of window controllers 514. For example, one network controller 512 may control at least tens, hundreds, or thousands of window controllers 514. Each window controller 514, in turn, may control and drive one or more electrochromic windows 502. In some embodiments, the network controller 512 can issue high level instructions such as the final tint state of a tintable window. The window controllers may receive these commands and directly control their associated windows, e.g., by applying electrical stimuli to appropriately drive tint state transitions and/or maintain tint states. The number and size of the tintable (e.g., electrochromic) windows 502 that each window controller 514 can drive, may be generally limited by the voltage and/or current characteristics of the load on the window controller 514 controlling the respective electrochromic windows 502. In some embodiments, the maximum window size that the window controller 514 can drive is limited by the voltage, current, and/or power requirements, to cause the requested optical transitions in the electrochromic window 502 within a requested time-frame. Such requirements are, in turn, a function of the surface area of the window. In some embodiments, this relationship is nonlinear. For example, the voltage, current, and/or power requirements can increase nonlinearly with the surface area of the electrochromic window 502. Without wishing to be bound to theory, in some cases the relationship is nonlinear at least in part because the sheet resistance of the first and second conductive layers increases nonlinearly with distance across the length and width of the first or second conductive layers. In some embodiments, the relationship between the voltage, current, and/or power requirements required to drive multiple electrochromic windows 502 of equal size and shape is directly proportional to the number of the electrochromic windows 502 being driven.

FIG. 5 shows an example of a master controller (MC) 511. The master controller 511 communicates and functions in conjunction with multiple network controllers 512, each of which network controllers 512 is capable of addressing a plurality of window controllers 514. In some embodiments, the master controller 511 issues the high level instructions (such as the final tint states of the tintable windows) to the network controllers 512, and the network controllers 512 then communicate the instructions to the corresponding window controllers 514. FIG. 5 shows an example of a hierarchical control system comprising the master controller, the network controllers, and the window controllers.

In some implementations, the various electrochromic windows 502, antennas, and/or other target devices of the facility (e.g., comprising building or other structure) are (e.g., advantageously) grouped into zones or groups of zones (e.g., wherein each of which includes a subset of the electrochromic windows 502). For example, each zone may correspond to a set of electrochromic windows 502 in a specific location or area of the facility that should be tinted (or otherwise transitioned) to the same or similar optical states, based at least in part on their location. As another example, consider a building having four faces or sides: A North face, a South face, an East Face, and a West Face. Consider that the building has ten floors. In such an example, each zone can correspond to the set of electrochromic windows 502 on a particular floor and on a particular one of the four faces. In some such embodiments, each network controller 512 can address one or more zones or groups of zones. For example, the master controller 511 can issue a final tint state command for a particular zone or group of zones to a respective one or more of the network controllers 512. For example, the final tint state command can include an abstract identification of each of the target zones. The designated network controllers 512 receiving the final tint state command may then map the abstract identification of the zone(s) to the specific network addresses of the respective window controllers 514 that control the voltage or current profiles to be applied to the electrochromic windows 502 in the zone(s).

In some embodiments, a distributed network of controllers is used to control one or more tintable windows. For example, a network system may be operable to control a plurality of IGUs in accordance with some implementations. One primary function of the network system may be to control the optical states of the electrochromic devices (or other optically-switchable devices) within the IGUs.

In some embodiments, another function of the network system is to acquire status information (e.g., data) from the IGUs. For example, the status information for a given IGU can include an identification of, or information about, a current tint state of the tintable device(s) within the IGU. The network system may be operable to acquire data from various sensors, such as temperature sensors, photosensors (referred to herein as light sensors), humidity sensors, air flow sensors, or occupancy sensors, antennas, whether integrated on or within the IGUs or located at various other positions in, on or around the building. At least one sensor may be configured (e.g., designed) to measure one or more environmental characteristics, for example, temperature, humidity, ambient noise, carbon dioxide, VOC, particulate matter, oxygen, and/or any other aspects of an environment (e.g., atmosphere thereof). The sensors may comprise electromagnetic sensors.

The electromagnetic sensor may be configured to sense ultraviolet, visible, infrared, and/or radio wave radiation. The infrared radiation may be passive infrared radiation (e.g., black body radiation). The electromagnetic sensor may sense radio waves. The radio waves may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHz, 8 MHz, 10 MHz, 15 MHz, 20 MHz, or 25 MHz. The radio waves may be at a high frequency of at most about 5 MHz, 8 MHz, 10 MHz, 15 MHz, 20 MHz, 25 MHz, or 30 MHz. The radio waves may be at any frequency between the aforementioned frequency ranges (e.g., from about 3 MHz to about 30 MHz). The radio waves may be at a very high frequency of at least about 30 Megahertz (MHz), 50 MHz, 80 MHz, 100 MHz, 150 MHz, 200 MHz, or 250 MHz. The radio waves may be at a very high frequency of at most about 50 MHz, 80 MHz, 100 MHz, 150 MHz, 200 MHz, 250 MHz, or 300 MHz. The radio waves may be at any frequency between the aforementioned frequency ranges (e.g., from about 30 MHz to about 300 MHz). The radio waves may be at an ultra-high frequency of at least about 300 kilohertz (MHz), 500 MHz, 800 MHz, 1000 MHz, 1500 MHz, 2000 MHz, or 2500 MHz. The radio waves may be at an ultra-high frequency of at most about 500 MHz, 800 MHz, 1000 MHz, 1500 MHz, 2000 MHz, 2500 MHz, or 3000 MHz. The radio waves may be at any frequency between the aforementioned frequency ranges (e.g., from about 300 MHz to about 3000 MHz). The radio waves may be at a super high frequency of at least about 3 gigahertz (GHz), 5 GHz, 8 GHz, 10 GHz, 15 GHz, 20 GHz, or 25 GHz. The radio waves may be at a super high frequency of at most about 5 GHz, 8 GHz, 10 GHz, 15 GHz, 20 GHz, 25 GHz, or 30 GHz. The radio waves may be at any frequency between the aforementioned frequency ranges (e.g., from about 3GHz to about 30 GHz).

The network system may include any suitable number of distributed controllers having various capabilities or functions. In some embodiments, the functions and arrangements of the various controllers are defined hierarchically.

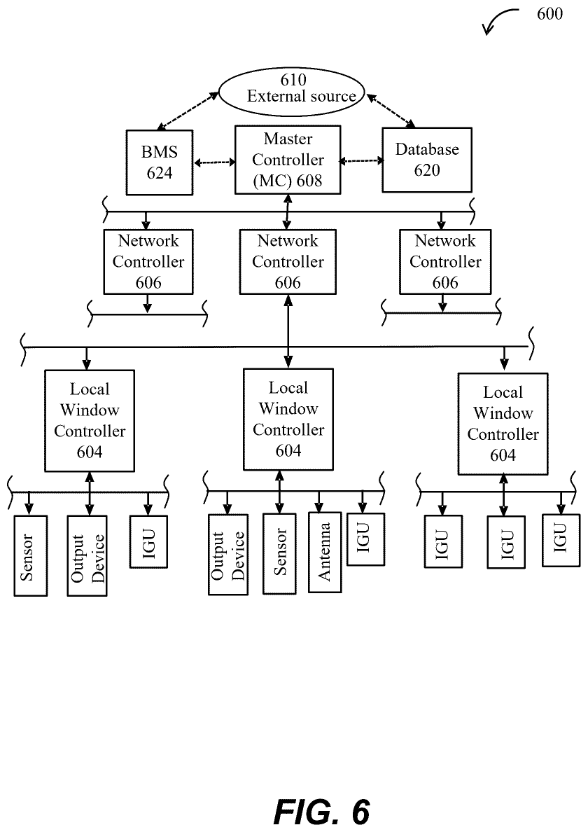

FIG. 6 shows an example of a network system 600 including a plurality of distributed local window controllers (WCs) 604, a plurality of network controllers (NCs) 606, and a master controller (MC) 608. In some embodiments, the MC 608 can communicate with and control at least two, ten, tens, hundred, or hundreds of floor using network controllers 606. The floor controller may be configured to control a floor or a portion of a floor. In various embodiments, the MC 608 issues high level instructions to the NCs 606 over one or more wired and/or wireless communication links. The instructions can include, for example, tint commands for causing transitions in the optical states of the IGUs controlled by the respective NCs 606. Each NC 606 may, in turn, communicate with and control a number of window controllers 604 over one or more wired and/or wireless links. The communication links may be bidirectional communication links. Master controller 608 is also in communication with a database 620, and a building management system (BMS) 624. The databased 620 and BMS 624 are in communication with an external source 610. In one implementation, external source 610 includes one or more sensors (e.g., a plurality of photosensors) and/or an cloud network.

The MC 608 may issue communications including tint commands, status request commands, data (for example, sensor data) request commands or other instructions. In some embodiments, the MC 608 issues such communications periodically, at certain predefined times of day (which may change based on the day of week or year), or based at least in part on the detection of particular events, conditions or combinations of events or conditions (for example, as determined by acquired sensor data or based at least in part on the receipt of a request initiated by a user and/or by an application or a combination of such sensor data and such a request). In some embodiments, when the MC 608 determines to cause a tint state change (e.g., alteration) in a set of one or more IGUs, the MC 608 generates or selects a tint value corresponding to the requested tint state. In some implementations, the set of IGUs is associated with a first protocol identifier (ID) (for example, a Building Automation and Control (BAC) network identification (BACnet ID)). The MC 608 may then generate and transmit a communication—referred to herein as a “primary tint command”—including the tint value and the first protocol ID over the link via a first communication protocol (for example, a BACnet compatible protocol). In some embodiments, the MC 608 addresses the primary tint command to the particular NC 606 that controls the particular one or more WCs 604 that, in turn, control the set of IGUs to be transitioned. The NC 606 may receive the primary tint command including the tint value and the first protocol ID and map the first protocol ID to one or more second protocol IDs. In some embodiments, each of the second protocol IDs identifies a corresponding one of the WCs 604. The NC 606 may subsequently transmit a secondary tint command including the tint value to each of the identified WCs 604 over the link via a second communication protocol. In some embodiments, each of the WCs 604 that receives the secondary tint command then selects a voltage and/or current profile from an internal memory based on the tint value to drive its respectively connected IGUs to a tint state consistent with the tint value. Each of the WCs 304 may then generate and provide voltage and/or current signals over the link to its respectively connected IGUs to apply the voltage or current profile.

In a similar manner to how the function and/or arrangement of controllers may be arranged hierarchically, tintable windows may be arranged in a hierarchical structure. A hierarchical structure can help facilitate the control of tintable windows at a particular site by allowing rules or user control to be applied to various groupings of tintable windows or IGUs. Further, for aesthetics, multiple contiguous windows in a room and/or other site location may sometimes need to have their optical states correspond and/or tint at the same rate. Treating a group of contiguous windows as a zone can facilitate these goals.

In some embodiments, IGUs are grouped into zones of tintable windows, each of which zones includes at least one window controller and its respective IGUs. Each zone of IGUs may be controlled by one or more respective NCs and one or more respective WCs controlled by these NCs. For example, each zone can be controlled by a single NC and two or more WCs controlled by the single NC.

In some embodiments, at least one device is operated in coordination with at least one other device, which devices are coupled to the network. Control of the at least one device may be via Ethernet. For example, A tint level of tintable windows may be adjusted concurrently. When the devices are in use, a zone of devices may have at least one characteristics that is the same. For example, when the tintable windows are in a zone, a zone of tintable windows may have its tint level (automatically) altered (e.g., darkened or lightened) to the same level. For example, when sounds sensors are in a zone, they may sample sound at the same frequency and/or at the same time window. A zone of devices may comprise a plurality of devices (e.g., of the same type). The zone may comprise (i) devices (e.g., tintable windows) facing a particular direction of an enclosure (e.g., facility), (ii) a plurality of devices disposed on a particular face (e.g., façade) of the enclosure, (iii) devices on a particular floor of a facility, (iv) devices in a particular type of room and/or activity (e.g., open space, office, conference room, lecture hall, corridor, reception hall, or cafeteria), (v) devices disposed on the same fixture (e.g., internal or external wall), and/or (vi) devices that are user defined (e.g., a group of tintable windows in a room or on a façade that are a subset of a larger group of tintable windows. The (automatic) adjustment of the devices may done automatically and/or by a user. The automatic changing of device properties and/or status in a zone, may be overridden by a user (e.g., by manually adjusting the tint level). A user may override the automatic adjustment of the devices in a zone using mobile circuitry (e.g., a remote controller, a virtual reality controller, a cellular phone, an electronic notepad, a laptop computer and/or by a similar mobile device).

In some embodiments, when instructions relating to the control of a device (e.g., instructions for a window controller or a tintable window) are passed through the network system, they are accompanied with a unique network ID of the device they are sent to. Networks IDs may be helpful to ensure that instructions reach and are carried out on the intended device. For example, a window controller that controls the tint states of more than one IGU, may determine which IGU (tintable window) to control based upon a network ID such as a Controller Area Network (CAN) ID (a form of network ID) that is passed along with the tinting command. In a window network such as those described herein, the term network ID includes but is not limited to CAN IDs, and BACnet IDs. Such network IDs may be applied to window network nodes such as window controllers, network controllers, and master controllers. A network ID for a device may include the network ID of every device that controls it in the hierarchical structure. For example, the network ID of an IGU may include a window controller ID, a network controller ID, and a master controller ID in addition to its own CAN ID.

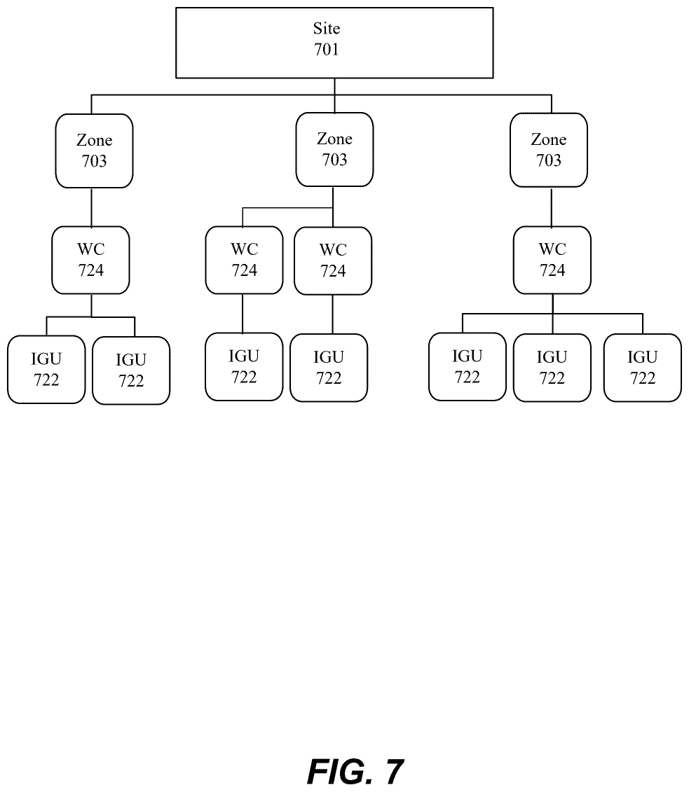

FIG. 7 shows various tintable windows (referred to as “IGUs”) 722 grouped into zones 703 of tintable windows. Each zone 703 includes at least one window controller (WC) 724 and one or more respective tintable windows 722. In some embodiments, each zone of tintable windows 722 is controlled by one or more respective NCs and one or more respective WCs 724 controlled by these NCs. Each zone 703 may be controlled by a single NC and two or more WCs 724 controlled by the single NC. Thus, a zone 703 can represent a logical grouping of the tintable windows 722. For example, each zone 703 may correspond to a set of one or more tintable windows 722 in a specific location or area of the building that are driven together based on their location or orientation. As a more specific example, consider a site 701 that is a building having ten floors and four faces or sides: A North face, a South face, an East Face, and a West Face. In such an example, each zone 703 may correspond to the set of one or more tintable windows 722 on a particular floor and on a particular one of the four faces. As another example, each zone 703 may correspond to a set of one or more tintable windows 722 that share one or more physical characteristics (for example, device parameters such as size or age). In some embodiments, a zone 703 of tintable windows 722 is grouped based at least in part on one or more non-physical characteristics comprising a security designation or a business hierarchy (for example, tintable windows 722 bounding managers' offices can be grouped in one or more zones while tintable windows 722 bounding non-managers' offices can be grouped in one or more different zones).

In some such implementations, each NC can address all of the tintable windows 722 in each of one or more respective zones 703. For example, the MC can issue a primary tint command to the NC that controls a target zone 703. The primary tint command can include an abstract identification of the target zone (hereinafter referred to as a “zone ID”). In some such implementations, the zone ID can be a first protocol ID such as that just described in the example above. The NC may receive the primary tint command including the tint value and the zone ID and may map the zone ID to the d protocol IDs associated with the WCs 724 within the zone. In some embodiments, the zone ID can be a higher level abstraction than the first protocol IDs. In such cases, the NC can first map the zone ID to one or more first protocol IDs, and subsequently map the first protocol IDs to the second protocol IDs.

### II. Commissioning

In order for tint controls to work (e.g., to allow the window control system to change the tint state of one or more specific tintable windows), a master controller, network controller, and/or other controller responsible for tint decisions, may utilize the network address of the window controller(s) connected to that specific window or set of windows. To this end, the network of tintable windows may be subjected to a commissioning process. A commissioning process is, at a high level, establishing which specific window(s) are connected to which specific controller(s), and, where each window is positioned within the window framing system of the building. Such commissioning may occur during and/or shortly after installation of the network of tintable windows.

The commissioning process may be used to determine several relevant types of information including, e.g., (1) the identification number of each tintable window, sometimes referred to as a lite ID; (2) the identification number of each window controller, sometimes referred to as a CAN ID when a CANBUS communication protocol is used; (3) the pairing between each tintable window and its associated window controller; and/or (4) the physical location of each tintable window. Once this information is known, a user can control the tint state of any one or more specific windows on the network, as desired.

In some embodiments, a goal of commissioning is to correct mistakes and/or other problems made in installing tintable windows in the wrong locations or connecting cables to the wrong window controllers. In some embodiments, a goal of commissioning is to provide semi- or fully-automated installation. In other words, allowing installation with little or no location guidance for installers. One advantage of the embodiments herein is that the tintable windows and window controllers can be installed in a building without consideration of the particular identification number for each component. This means that an installer does not have to look for a particular component (e.g., having a particular ID number according to a pre-determined list or map) when installing a tintable window at a given location, nor do they have to diligently record the ID number of each component as it is installed. Rather, the components can be installed with a high degree of flexibility without regard to ID numbers, and the relevant ID numbers can be determined at a later time through the commissioning process. This technique substantially reduces the time and errors associated with conventional commissioning processes in which the relevant IDs are pre-mapped and/or manually recorded during installation and correlated with window positions in the framing system.

In some embodiments, the commissioning process for a particular tintable window may involve associating an ID for a device (e.g., the tintable window and/or window-related component), with its corresponding local controller. The commissioning process may assign a building location, a relative location, and/or an absolute location (e.g., latitude, longitude, and elevation) to the device (e.g., window or another component). Examples relating to commissioning and/or configuring a network of tintable windows can be found in U.S. patent application Ser. No. 14/391,122, filed Oct. 7, 2014, titled “APPLICATIONS FOR CONTROLLING OPTICALLY SWITCHABLE DEVICES,” U.S. patent application Ser. No. 14/951,410, filed Nov. 24, 2015, titled “SELF-CONTAINED EC IGU,” PCT Patent Application No. PCT/US2017/020805, filed Mar. 3, 2017, titled “METHOD OF COMMISSIONING ELECTROCHROMIC WINDOWS,” U.S. patent application Ser. No. 16/462,916, filed May 21, 2019, and titled “AUTOMATED COMMISSIONING OF CONTROLLERS IN A WINDOW NETWORK,” PCT Patent Application No. PCT/US2021/057678, filed Nov. 2, 2021, and titled “VIRTUALLY VIEWING DEVICES IN A FACILITY,” U.S. patent application Ser. No. 15/727,258, filed Oct. 6, 2017, and titled “COMMISSIONING WINDOW NETWORKS,” PCT Patent Application No. PCT/US2017/066486, filed Dec. 14, 2017, and titled “TESTER AND ELECTRICAL CONNECTORS FOR INSULATED GLASS UNITS,” PCT Application No. PCT/US2021/062774, filed Dec. 10, 2021, and titled “COMPONENT UPDATES IN A MULTI COMPONENT NETWORK,” PCT Application No. PCT/US2021/023834, filed Mar. 24, 2021, and titled “ACCESS AND MESSAGING IN A MULTI CLIENT NETWORK,” each of which is herein incorporated by reference in its entirety.

After a network of devices (e.g., one or more tintable windows) is physically installed, the network can be commissioned to establish the aforementioned window(s)-to-controller correlation and correct any incorrect assignment of window controllers to the wrong tintable windows (sometimes referred to as “IGUs”) or building locations. In some embodiments, commissioning maps pair or link individual devices (e.g., tintable windows) and their locations with associated controllers.

Various embodiments for commissioning a network of tintable windows are described herein. In various embodiments, commissioning involves interacting with a tintable window in such a way to cause a signal to propagate through the window and upstream to through its associated controllers in order to establish and record the window-to-controller correlation. The signal begins at the tintable window and passes through its associated window controller before being propagated to a network controller, BMS, or other portion of a control system. As the signal passes through the tintable window and its associated window controller, the pairing between these components, as well as the IDs of the components, can be determined based on how the signal propagates through the network. The signal is generated by an interaction between a user and the window, either the user sends an externally generated signal through the window (in many cases via the electrochromic device and/or associated wiring) or the signal is internally induced in the window using the electrochromic device and/or powering and/or control circuitry and/or other component(s) of the window assembly. Various components of the window assembly can be used for this purpose, including but not limited to the electrochromic device and/or components of the powering and/or control mechanisms, e.g. transparent conductive layers, bus bars, antenna, onboard memory chip, power and communication wiring, RFID tag or other circuitry can be used to create and propagate a signal via an applied force and/or energy acting on any of these components or a combination of such components.

The location of the tintable windows can be determined based on which tintable window was subjected to the interaction that caused the signal to be generated. Various types of interactions may be used to generate the signal. In some embodiments, commissioning further involves instructing one or more tintable window to identify itself by generating a signal that can be detected. The location of the relevant tintable window can be determined by detecting which window is sending the signal upstream to the controller(s).

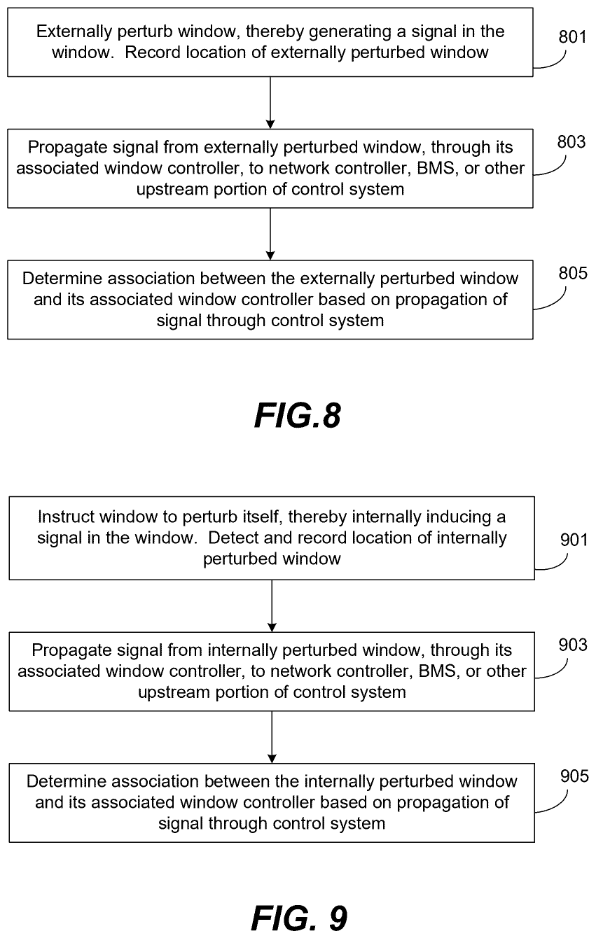

FIG. 8 presents a flowchart for a method of commissioning a network of tintable windows according to various embodiments herein. The method begins with operation 801, where a window is externally perturbed, thereby causing the window to generate a signal. As used herein, an external perturbation involves directing energy toward a window from a source other than the window. Often, the source of the external perturbation is an installer, robot, drone, etc., who may perturb the window using their body, a tool, or a combination thereof. Various types of external perturbation may be used, as discussed below.

The signal may be an electrical signal, or it may be another type of signal that can be converted into an electrical signal. During operation 801, the physical location of the window being externally perturbed may be recorded. Such recording may be done using a map, list, etc. In some cases, the map or list may include a pre-determined set of window locations, and the relevant location may be selected from the map or list of such locations. In various embodiments, an installer (or robot, drone, etc.) identifies and records the physical location of a window that they are causing to be externally perturbed.

Next, at operation 803, the signal is propagated from the window, through its associated window controller, to a network controller, master controller, BMS, and/or other upstream portion of a control system. Software may be used to detect and/or record how the signal is propagated through the system. For example, as each window sends a signal upstream, the electrical pathway is recorded and stored in a ledger. Once all the windows have sent signals, a complete ledger of window-to-controller correlations is established. From this, a system map may be generated with the appropriate window IDs and associated window controller IDs paired as discovered in the commissioning process. The system map may include GUIs representing the building in 2D or 3D, including smart objects in a digital twin fashion, so that users can manipulate the model to see which window is paired with which controller.

This signal propagation can be used to provide a substantial amount of information regarding the layout of the network and the various components therein. As such, the method continues with operation 805, where the association between the window and its associated window controller is determined based on propagation of the signal through the control system. For example, when a window is perturbed to generate a signal that is passed through its associated window controller, the control system can easily determine which window controller is associated with the window that was perturbed, for example based on identifying which window controller received the signal from the window and propagated the signal to the rest of the control system. In this way, the associations between the windows and their window controllers can be easily determined. The system map described above may be generated as part of operation 805.

This process can also be used to identify the particular IDs of the windows and their associated window controllers. For instance, each window can include a memory chip that contains relevant information about the particular window. Such information can include the window ID (e.g., lite ID) and other parametric information unique or otherwise relevant to that particular window. In various embodiments, the memory chip may be provided as part of a window, for example integral with the window or in a connector that connects to or is part of the window. Such a connector may be referred to as a smart window connector. The window may be connected to its associated window controller via the smart window connector or other electrical connector. Through this connection, the window controller can read the ID of its associated window. This ID information can then be passed along to the rest of the control system.

Likewise, the window controller can include a memory chip that contains relevant information about the particular window controller. Such information can include the ID of the window controller (e.g., the CAN ID) and other information relevant to the window controller. In this way, the window controller can easily identify itself to other components of the control system. As the signal from perturbing the window propagates from the window and through the associated window controller, the associated window controller can identify itself to upstream components of the network such as the network controller, BMS, etc. based on this stored ID information.

Generally, signal strength can be used to determine when it is appropriate to detect a perturbance of a window. A signal strength threshold can be used to detect such a perturbance, thereby reducing the risk that cross talk or noise overwhelms the system. For example, if an external signal is applied or an external force or energy is used to generate a signal in the window, the strength of the signal may be such that adjacent windows experience it. In such cases, the window experiencing the strongest signal may be used as the only one in that specific instance to map a window to controller correlation.

In various implementations, operation 805 may further involve determining an association between a window controller and its associated network controller or other upstream controller. The associated network controller or other upstream controller may be identified in the same or similar way as the window controller is identified, for example based on propagation of the perturbation signal through the network (in particular through the network controller or other upstream controller) and stored ID information. In this way, the entire control network can be mapped out, with all relevant components being easily identified and associated with one another as needed.

The method of FIG. 8 may be repeated any number of times. The method may be repeated on different tintable windows until the associations between each window and its associated window controller are determined. In these or other embodiments, the method may be repeated on one or more particular window, for example to confirm that the correct association has been determined.

There are a number of ways that the method of FIG. 8 may be implemented. Various details are discussed below. These details may be selected and combined as desired for a particular application.

One technique that may be used for externally perturbing the window involves tapping, knocking, or otherwise physically contacting the window to cause vibrations or other pressure changes in the window and/or one or more components therein. This contact may be done by an installer, often referred to as a field service engineer. Alternatively or in addition, the contact may be done by a mobile non-human device such as a robot, drone, etc.

The vibrations or other pressure changes associated with the physical contact can be converted into an electrical signal at the window using one or more sensors or other devices. Example devices include, but are not limited to, accelerometers, microphones, piezoelectric sensors, pressure sensors, antennae, etc.

The device used to convert the vibrations or other pressure changes into an electrical signal may be located anywhere on the window. In some embodiments, the device is located on a frame of the window, on a lite of the window, or between the lites of the window. In cases where the device is on a lite, it may be directly or indirectly attached to the lite, or it may be etched or otherwise formed directly in/on the glass. In some embodiments, the device is located in the sealed interior region of an IGU (e.g., between lites of the IGU and peripherally interior of a spacer). In other embodiments, the device is located outside of the sealed interior region of the IGU. In some embodiments, the device may be mounted on a spacer, either interior or exterior of the spacer, or within the spacer. Similarly, the device may be mounted on a spacer key, interior or exterior of the spacer key, or within the spacer key. In some embodiments, the device may be mounted wholly or partially within a secondary seal that surrounds the spacer. In some embodiments, the device may be located in a capillary tube in fluidic communication with the sealed interior region of the IGU. Such capillary tubes are commonly used to equalize pressure as needed during shipping. The capillary tube may be a particularly useful location when the device is a pressure sensor. While the optimal placement of the device may depend on a number of factors including the type of device, any of the devices described herein for generating an electrical signal may be disposed at any of the locations mentioned herein.

In one example of the method of FIG. 8, a window is externally perturbed by tapping or knocking on the window in operation 801. The physical location of the window being perturbed is recorded. The perturbation and recording may be done by an installer, a robot, a drone, or a combination thereof. The vibrations caused by the tapping are converted into an electrical signal by one or more devices selected from the group consisting of an accelerometer, a microphone, a piezoelectric sensor, a pressure sensor, and an antenna. The device may be located anywhere on the window, including but not limited to any of the locations mentioned above. In operation 803 the electrical signal propagates from the window, through its associated window controller, to a network controller, master controller, or other upstream portion of the control system network. As the signal passes through the various controllers, the IDs (e.g., lite ID, CAN ID, etc.) of the relevant components may be added to signal. The ID of the window, window controller, and any other upstream controllers, as well as the association between these components, can be easily determined in operation 805 based on how the electrical signal propagates through the network (e.g., by analyzing which controller(s) pass the relevant signal and/or by analyzing the content of the signal and/or by analyzing a ledger and/or map in which the electrical pathways are recorded as described above). Likewise, the association between the window ID and the physical location of that window can be determined in operation 805 based on recordation of which window was externally perturbed during operation 801 and the resulting signal propagation through the control system network.

In another example in line with the embodiment of FIG. 8, a window is perturbed in operation 801 by pressing on the window, for example on a lite, frame, or other portion of the window. A pressure sensor is provided in a location suitable for detecting the pressure change associated with pressing on the window. For instance, the window may be perturbed by pressing on a lite, and a pressure sensor located within the sealed interior region of an IGU may be configured to sense the pressure change. In a similar example, the window may be perturbed in operation 801 by pressing on its frame, and a pressure sensor located within or on the frame may be configured to sense the pressure change. In either case, the signal from the external perturbation is propagated through the control system network as described above to identify the IDs of the relevant components, the associations between them, and the physical location of each window.

In a related embodiment in line with FIG. 8, the technique used for generating the signal in the window in operation 801 involves externally generated sound-based perturbation. For instance, a detectible audio signal may be directed at a particular window, thereby causing the window (and/or one or more components therein) to vibrate. This technique does not require physical contact with the window, but otherwise operates in essentially the same way as the above examples. The audio signal directed toward the window may be generated through any available means including, but not limited to, an electronic speaker, a human voice, clapping, etc. The signal may be at various wavelengths, including but not limited to subsonic, sonic, ultrasonic and hypersonic. Sound may be generated using a device that is held proximate the window or that comes in contact with the window, e.g. a horn or speaker touching the window glass. Where sound-based perturbation is used, more than one window may be simultaneously perturbed, thereby complicating the analysis. Relative signal strength may be used to determine which window is the primary window at which the sound-based perturbation is aimed, as described above.

Light-based perturbation techniques may also be used. For instance, a light or laser may be directed at a particular window that includes a photosensor or other sensor configured to detect such a light-based input. The sensor may be configured to output an electrical signal that is propagated through the control system network as described above upon detection of an appropriate light-based perturbation.

In another example in line with FIG. 8, the technique used for generating the signal in the window in operation 801 involves direct electrical perturbation of the window or one or more components therein. Generally, such embodiments may involve directing an RF signal at the window (or a particular component therein such as the bus bars, antenna, etc.) from an external source, and monitoring the system for an RF ripple feedback signal from the window. In some embodiments, an electromagnetic pulse (EMP) may be used to generate a signal in the window components. In yet other embodiments, an induction coil is used to send a magnetic signal to the window which in turn is converted to an electrical signal; this may be associated with a receiving coil in the window. In some embodiments, an installer (or robot, drone, etc.) can use an electromagnetic coil or antenna that induces an electrical signal in the window when brought into close proximity with the window. In various examples, the electromagnetic coil or antenna may be provided in a tool such as a wand, which may be carried around a building by an installer (or robot, drone, etc).

The wand may inductively and/or capacitively couple with one or more components of the window. In some cases, the wand may be used to induce an electrical field in the glass when held proximate the glass. This electrical field results in a charge, which translates into an electrical signal that can be propagated through the control system network. In some examples, the wand may electromagnetically interact with the bus bars of an electrochromic device positioned on the window, thereby causing an electrical signal that can be propagated through the control system network. In some examples, the wand may electromagnetically interact with an antenna positioned on the window, thereby causing an electrical signal that can be propagated through the control system network. Generally, the window may include any component or combination of components that can be used to receive an RF signal and convert the RF signal into an electrical signal that can be propagated through the control system network. Examples of such components include, but are not limited to, bus bars and antennae.

In various examples in line with the embodiment of FIG. 8, an installer (or robot, drone, etc.) externally perturbs a particular window in operation 801 by positioning a wand having an electromagnetic coil and/or antenna therein proximate the window. The wand may provide power to the electromagnetic coil and/or antenna. The electromagnetic coil and/or antenna may be configured to produce a signal that can be transmitted to the window when in close proximity to the window. As such, the wand is the source of the external perturbation on the window. For instance, one or more component in the window (such as the bus bars, antenna, or other RF receiver) generates or receives a signal (e.g., an electrical signal, or a signal that can be converted into an electrical signal) in response to the wand coming into close proximity with the window. The location of the window that is perturbed is recorded. In operation 803, the electrical signal is propagated from the window, through its associated window controller, and onto the network controller, BMS, or other upstream control component, as described above. In operation 805, the IDs of the relevant components (e.g., lite ID of the window and CAN ID of the associated window controller), as well as the associations between them, are determined as described above. Likewise, the physical location of the window is associated with the window ID based on the information recorded during operation 801 and propagation of the perturbation signal during operation 803.

Internal and external antennas for use with electrochromic windows are further discussed in PCT Application No. PCT/US2015/062387, filed Nov. 24, 2015, and titled “WINDOW ANTENNAS,” PCT Application No. PCT/US2017/031106, filed May 4, 2017, and titled “WINDOW ANTENNAS,” U.S. application Ser. No. 15/709,339, filed Sep. 19, 2017, and titled “WINDOW ANTENNAS FOR EMITTING RADIO FREQUENCY SIGNALS,” and PCT Application No. PCT/US2020/032269, filed May 9, 2020, and titled “ANTENNA SYSTEMS FOR CONTROLLED COVERAGE IN BUILDINGS,” which is herein incorporated by reference in its entirety and for all purposes. In some cases, an antenna may be provided on a lite of a window, and such antenna may be configured to generate or receive a signal (e.g., an RF signal) from a wand as described above. In some such cases, the antenna may be referred to as a patch antenna. In some such cases, an antenna is patterned using one or both conductors of the electrochromic device on the glass of the window, such antennas include patch, fractal and other antennas.

In any of the embodiments herein, the window controller (and optionally, network controllers, BMS, or other upstream control components) may be specially configured to process and propagate the electrical signals described herein. For instance, such window controllers may be configured to operate at a particular speed in order to handle the relevant frequencies.

In various examples above, the window is perturbed by an external source. In some other examples, a window may be instructed to perturb itself. Such internally-induced perturbations can likewise be used to identify particular windows and window controllers, the associations between them, and the physical locations of the windows. Windows can be internally perturbed in a number of ways, including but not limited to any of the techniques described herein for external perturbations. In such cases, the window can include one or more device for causing such a perturbation (e.g., a moving part that strikes or otherwise contacts a portion of the lite, spacer, frame, or other portion of the window; a speaker; a moving part that completes an electrical circuit, antennae, bus bars, etc.) and (if needed) one or more device for converting the signal from the perturbation to an electrical signal (e.g., one or more sensor such as an accelerometer, microphone, piezoelectric sensor, pressure sensor, antennae, etc.) that is then propagated to the upstream components of the control system network.

FIG. 9 presents a flowchart for a method of commissioning a network of electrochromic windows that involves causing the windows to internally perturb themselves using a technique that can be detected. Unless otherwise in conflict, details provided in relation to the embodiment of FIG. 8 may also apply to the embodiment of FIG. 9. In the embodiment of FIG. 9, the method starts with operation 901, where a particular window on a control system network is instructed to perturb itself, thereby internally inducing a signal in the window. For instance, the control system network may instruct the devices on the network that a particular window should be perturbed in a particular way. This instruction may be provided to one or more (in many cases all) windows on the network, since the network layout is not yet known. When the appropriate window receives the instruction to perturb itself (the appropriate window being identified based on its lite ID, for example, which may be accessible to its associated window controller as described above), the window follows the instruction to perturb itself, thereby internally inducing a signal in the relevant window. The perturbation can take various forms as discussed herein. In various examples, operation 901 involves causing a window to perturb itself, thereby internally inducing a signal on the window being perturbed, where the signal is detectible by an installer (or robot, drone, etc.). The signal may be an RF signal, and it may be generated and/or propagated by one or more component on the window, such as the bus bars and/or an antenna etched, deposited, or otherwise formed on the window. The signal may be received by a sensor configured to receive it. The sensor may be provided on a wand or other tool that may be carried by an installer (or robot, drone, etc.) to identify which window is being internally perturbed. Once the location of the internally perturbed window is detected/identified, this information is recorded.

In addition, the perturbation is converted into an electrical signal (if such a conversion is needed), which is then propagated from the window to its associated window controller and then onto the network controller, BMS, or other upstream control component in operation 903. Generally, operation 903 of FIG. 9 is analogous to operation 803 of FIG. 8, and details that apply to operation 803 may also apply to operation 903. For the sake of brevity, such details will not be repeated. Because the instruction for the window to perturb itself is widely distributed to the various windows, there are many windows that receive the signal that do not take any action. Only the window that is particularly identified (e.g., by its lite ID) will take action to perturb itself in operation 901. At operation 905, the IDs of the relevant components (e.g., lite ID of the window and CAN ID of the associated window controller), as well as the associations between them, are determined as described above. Operation 905 of FIG. 9 is analogous to operation 805 of FIG. 8, and any details provided with respect to operation 805 may also apply to operation 905. Likewise, the physical location of the window is associated with the window ID in operation 905 based on the location information recorded during operation 901 and propagation of the perturbation signal during operation 903.

In various embodiments of the method of FIG. 9, an installer (or robot, drone, etc.) may monitor and optionally record the windows during operation 901 to determine which window is being internally perturbed at a particular time. In some cases the window may include one or more indicator that may be used to further identify when that particular window is being perturbed, to make such determinations easier. Various types of indicators can be used including, but not limited to, indicators that provide light- or sound-based indications. In some other cases, the window being perturbed is identified based on a signal generated from the perturbation itself. For instance, the perturbation may involve generating a signal on the bus bars and/or antenna of the window, where the signal is both (i) detected by an installer using a wand or other tool as described above to thereby determine the physical location of the perturbed window, and (ii) propagated from the perturbed window, through its associated window controller, to thereby determine the association between the perturbed window and its associated window controller.

Terms such as “a”, “an” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling (e.g., communicative coupling). The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. The electrical circuitry may be configured to coupe to an electrical power source (e.g., to the electrical grid). For example, the electrical circuitry may comprise a socket. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

Modifications, additions, or omissions may be made to any of the above-described implementations without departing from the scope of the disclosure. Any of the implementations described above may include more, fewer, or other features without departing from the scope of the disclosure. Additionally, the steps of described features may be performed in any suitable order without departing from the scope of the disclosure. Also, one or more features from any implementation may be combined with one or more features of any other implementation without departing from the scope of the disclosure. The components of any implementation may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C #, C++ or Python, LabVIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic medium such as a hard-drive or a floppy disk, or an optical medium such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed implementations have been described in some detail to facilitate understanding, the described implementations are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain implementations herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or implementations of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. A method of determining an association between an optically switchable window and its associated window controller in a network of optically switchable windows, the method comprising:
perturbing the optically switchable window to cause the optically switchable window to generate or receive a signal;
propagating the signal from the optically switchable window, through its associated window controller, to an upstream portion of the network; and
determining the association between the optically switchable window and its associated window controller based on which optically switchable window was perturbed and which window controller propagated the signal.

2. The method of claim 1, further comprising recording a location of the optically switchable window that is perturbed.

3. The method of claim 1 or 2, further comprising determining an identification number for the optically switchable window that is perturbed, wherein the identification number is determined based on an identification number stored on a memory chip that is integral with or connected to the optically switchable window that is perturbed.

4. The method of any of claims 1-3, further comprising determining an association between (1) the identification number for the optically switchable window that is perturbed, and (2) the location of the optically switchable window that is perturbed.

5. The method of any of claims 1-4, wherein determining the association between the optically switchable window and its associated window controller comprises determining an association between (1) the identification number for the optically switchable window that is perturbed, and (2) an identification number for the associated window controller that propagates the signal.

6. The method of any of claims 1-5, wherein perturbing the optically switchable window comprises one or more actions from the group consisting of: physically contacting one or more component of the optically switchable window or its associated frame, causing a pressure change in one or more component of the optically switchable window, causing vibrations in one or more component of the optically switchable window, directing sound toward one or more component of the optically switchable window, directing an electrical signal toward one or more component of the optically switchable window, directing an RF signal toward one or more component of the optically switchable window, or a combination thereof.

7. The method of any of claims 1-6, further comprising converting a signal generated or received by the optically switchable window that is perturbed to an electrical signal, wherein the electrical signal is the signal that is propagated through the associated window controller and to the upstream portion of the network.

8. The method of any of claims 1-7, wherein the optically switchable window is perturbed by a source external to the optically switchable window.

9. The method of claim 8, wherein the source that perturbs the optically switchable window is an installer, robot, or drone.

10. The method of any of claims 1-7, further comprising instructing the optically switchable window to perturb itself.

11. The method of claim 10, wherein the optically switchable window that perturbs itself comprises bus bars and/or an antenna, and wherein the optically switchable window perturbs and/or identifies itself by transmitting a signal using the bus bars and/or the antenna.

12. The method of claim 11, further comprising detecting the signal transmitted by the bus bars and/or antenna to determine a physical location of the optically switchable window that is perturbed, and recording the physical location of the optically switchable window that is perturbed.

13. The method of any of claims 1-12, further comprising repeating the method on different optically switchable windows until all of the associations between each optically switchable window and its associated window controller are determined.

14. A control system for a network of optically switchable windows, the control system comprising:
a plurality of optically switchable windows, each having an associated window controller;
an upstream portion of the control system, the upstream portion of the control system being functionally upstream from the plurality of optically switchable windows and their associated window controllers; and
a memory configured to cause:
perturbing a first optically switchable window of the plurality of optically switchable windows to cause the first optically switchable window to generate or receive a signal,
propagating the signal from the first optically switchable window, through its associated window controller, to the upstream portion of the control system, and
determining the association between the first optically switchable window and its associated window controller based on which optically switchable window was perturbed and which window controller propagated the signal.

15. The control system of claim 14, wherein the control system is configured to accept as input a location of the first optically switchable window, the location being determined by an installer, robot, or drone who perturbs the first optically switchable window or otherwise causes the first optically switchable window to be perturbed.

16. The control system of claim 14 or 15, wherein the memory is further configured to cause determining an identification number for the first optically switchable window, wherein the identification number is determined based on an identification number stored on a memory chip that is integral with or connected to the first optically switchable window.

17. The control system of any of claims 14-16, wherein the memory is further configured to cause determining an association between (1) the identification number for the first optically switchable window, and (2) the location of the first optically switchable window.

18. The control system of any of claims 14-17, wherein the memory is configured to cause determining the association between the first optically switchable window and its associated window controller by determining an association between (1) the identification number for the first optically switchable window, and (2) an identification number for the associated window controller that propagates the signal.

19. The control system of any of claims 14-18, wherein the memory is configured to cause perturbing the first optically switchable window by causing one or more actions from the group consisting of: physically contacting one or more component of the first optically switchable window or its associated frame, causing a pressure change in one or more component of the first optically switchable window, causing vibrations in one or more component of the first optically switchable window, directing sound toward one or more component of the first optically switchable window, directing an electrical signal toward one or more component of the first optically switchable window, directing an RF signal toward one or more component of the first optically switchable window, or a combination thereof.

20. The control system of any of claims 14-19, wherein the memory is further configured to cause converting a signal generated or received by the first optically switchable window to an electrical signal, wherein the electrical signal is the signal that is propagated through the associated window controller and to the upstream portion of the control system.

21. The control system of any of claims 14-20, wherein the first optically switchable window is perturbed by a source external to the first optically switchable window.

22. The control system of claim 21, wherein the source that perturbs the first optically switchable window is an installer, robot, or drone.

23. The control system of any of claims 14-20, wherein the memory is further configured to cause the first optically switchable window to perturb itself.

24. The control system of claim 23, wherein the first optically switchable window comprises bus bars and/or an antenna, and wherein the first optically switchable window perturbs and/or identifies itself by transmitting a signal using the bus bars and/or the antenna.

25. The control system of claim 24, wherein the signal transmitted by the bus bars and/or antenna is detected by an installer, robot, or drone to determine a physical location of the first optically switchable window.
